(19) United States
(12) Patent Application Publication
(10) Pub. No.: US 2019/0240943 A1
(43) Pub. Date: Aug. 8, 2019

(54) PACKAGING ASSEMBLY SYSTEM

(71) Applicant: Sealed Air Corporation (US), Charlotte, NC (US)

(72) Inventors: Thomas Orsini, Leominster, MA (US); Daniel Lafrance, Worcester, MA (US); Christof Hammerschmidt, Wiesbaden (DE)

(21) Appl. No.: 16/344,490

(22) PCT Filed: Oct. 24, 2017
(86) PCT No.: PCT/US2017/058012

§ 371 Date: Apr. 24, 2019

Related U.S. Application Data
(60) Provisional application No. 62/412,387, filed on Oct. 25, 2016.

(51) Int. Cl. B31B 50/62; B65D 5/50; B65D 81/05

(52) U.S. Cl. CPC B31B 50/626; B31B 50/622; B31B 2105/0024; B65D 81/05; B65D 5/5028

(57) ABSTRACT

A system for assembling a packaging assembly of a box and a frame (i) a conveyor for transporting the box along a path of travel in an inverted position with the front and rear closure flaps extending in an open configuration, (ii) an adhesive application station for applying adhesive to the front and rear closure flaps in selected regions, and (iii) a compression station downstream from the adhesive application station to compress (1) the front panel flap to the front closure flap and (2) the rear panel flap to the rear closure flap in the selected regions.

### BACKGROUND

Various embodiments of the presently disclosed subject matter relate to frames useful in packaging assemblies for retaining a product in a box, and to the packaging assemblies incorporating those frames, for example, packaging assemblies used to protect a packaged product during shipment by retaining the product within a box.

Protective packaging structures may be used to help protect a product during transport, for example, from physical shock, dust, and other contaminants. For example, a product may be enclosed in a box with additional packing materials (e.g., crumpled paper, air-filled plastic cushions, molded foam) to restrain the product movement inside the box and to cushion the product.

One type of packaging assembly is known as “suspension packaging.” In typical suspension packaging, the packaged product is suspended between two sheets each attached to opposing frames sized to fit within a corresponding box. Another type of packaging assembly is known as retention packaging. In typical retention packaging, a product is retained between a sheet and a rigid backing frame to which the sheet is attached. Examples of retention and suspension packaging are described in more detail in U.S. Pat. Nos. 4,852,743; 4,923,065; 5,071,009; 5,287,968; 5,388,701; 5,678,695; 5,893,462; 6,010,006; 6,148,590; 6,148,591; 6,289,655; 6,302,274; 6,311,844; and 6,899,229; each of which is incorporated herein in its entirety by reference; and in U.S. Patent Application Ser. No. 62/049,048 filed Sep. 11, 2014, which is also incorporated herein in its entirety by reference.

While existing retention structures provide a level of protection for the packaged object, there is room for improvement, for example, by any of enhancing the protective qualities, reducing the cost of the structure, and providing a frame design more conducive to automated installation in a packaging system.

### SUMMARY

The presently disclosed subject matter may address one or more of the aforementioned problems.

An embodiment is directed to a system for assembling a packaging assembly of a box and a frame. The box has a left wall, a right wall opposing the left wall, a front wall extending from the left wall to the right wall, and a rear wall opposing the front wall, extending from the left wall to the right wall. A front closure flap is foldably connected to the top of the front wall along a front closure flap fold line. A rear closure flap foldably connected to the top of the rear wall along a rear closure flap fold line. A box length extends from the interior of the left wall to the interior of the right wall. A box width extends from the interior of the front wall to the interior of the rear wall. The frame includes a panel and a sheet. The panel has a panel width from the front edge to the rear edge of the panel. The panel width is greater than the box width. The frame has a front panel flap fold zone extending generally perpendicularly from the left edge to the right edge of the panel and having one or more front panel flap fold lines. The front panel flap fold zone corresponds to the front closure flap fold line of the box. The frame has a rear panel flap fold zone extending generally perpendicularly from the left edge to the right edge of the panel and having one or more rear panel flap fold lines. The rear panel flap fold zone corresponds to the rear closure flap fold line of the box. The frame has a central panel portion extending between the front and rear panel flap fold zones. A front panel flap extends from the front panel flap fold zone to the front edge of the panel. A rear panel flap extending from the rear panel flap fold zone to the rear edge of the panel. A detachment line extending from the left edge to the right edge of the panel in the central panel portion to delineate (i) a front central panel portion between the detachment line and the front panel flap fold zone and (ii) a rear central panel portion between the detachment line and the rear panel flap fold zone. The sheet extends across the central panel portion and is attached to the panel at opposing regions of the panel outside of the central panel portion. The system includes (i) a conveyor for transporting the box along a path of travel in an inverted position with the front and rear closure flaps extending in an open configuration, (ii) an adhesive application station for applying adhesive to the front and rear closure flaps in selected regions, and (iii) a compression station downstream from the adhesive application station. The compression station compresses (1) the front panel flap to the front closure flap and (2) the rear panel flap to the rear closure flap in the selected regions.

These and other objects, advantages, and features of the presently disclosed subject matter will be more readily understood and appreciated by reference to the detailed description and the drawings.

### BRIEF DESCRIPTION OF THE DRAWING

FIG. 1 is a representative top down plan view of a frame embodiment of the presently disclosed subject matter;

FIG. 2 is a representative bottom up plan view of the frame of FIG. 1;

FIG. 3 is a representative perspective view of a packaging assembly embodiment of the presently disclosed subject matter comprising a box and the frame of FIGS. 1-2 in an installed position with the sheet side down;

FIG. 4 is a representative perspective view of the packaging assembly of FIG. 3, but having the front and rear central panel portions lifted open and a product to be packaged placed on the sheet;

FIG. 5 is a representative perspective view of the packaging assembly of FIG. 4, but having the left and right closure flaps of the box folded inwardly on top of the central panel;

FIG. 6 is a representative perspective view of the packaging assembly of FIG. 5, but in the retained position with the box closed, having the front and rear closure flaps folded inwardly;

FIG. 7 is a representative sectional view taken along the line 7-7 of FIG. 6;

FIG. 8 is a representative sectional view taken along the line 8-8 of FIG. 6;

FIG. 9 is a representative perspective view of the packaging assembly of FIG. 4, but having the left and right closure flaps of the box folded inwardly beneath the central panel;

FIG. 10 is a representative perspective view of the packaging assembly of FIG. 9, but in the retained position with the box closed, having the front and rear closure flaps folded inwardly;

FIG. 11 is a representative sectional view taken along the line 11-11 of FIG. 10;

FIG. 12 is a representative sectional view taken along the line 12-12 of FIG. 10;

FIG. 13 is a representative perspective view of a packaging assembly embodiment of the presently disclosed subject matter comprising a box and the frame of FIGS. 1-2 in an installed position with the sheet side up;

FIG. 14 is a representative perspective view of the packaging assembly of FIG. 13, but having a product to be packaged placed on the sheet;

FIG. 15 is a representative perspective view of the packaging assembly of FIG. 14, but having the left and right closure flaps of the box folded inwardly on top of the product;

FIG. 16 is a representative perspective view of the packaging assembly of FIG. 15, but in the retained position with the box closed, having the front and rear closure flaps folded inwardly;

FIG. 17 is a representative sectional view taken along the line 17-17 of FIG. 16;

FIG. 18 is a representative sectional view taken along the line 18-18 of FIG. 16;

FIG. 19 is a representative top down plan view of another frame embodiment of the presently disclosed subject matter;

FIG. 20 is a representative bottom up plan view of the frame of FIG. 19;

FIG. 21 is a representative bottom up plan view of the frame of FIG. 19 as in FIG. 20, but having an adhesive on the sheet-uncovered portion of the front and rear panel flaps;

FIG. 22 is a representative perspective view of a packaging assembly embodiment of the presently disclosed subject matter comprising a box and the frame of FIG. 21 in an installed position and having the front and rear central panel portions lifted open and a product to be packaged placed on the sheet;

FIG. 23 is a representative perspective view of the packaging assembly of FIG. 22, but having the left and right closure flaps of the box folded inwardly on top of the product;

FIG. 24 is a representative perspective view of the packaging assembly of FIG. 23, but having the box partially closed, having the front closure flap folded inwardly;

FIGS. 25 to 32 are not used;

FIG. 33 is a representative top down plan view of another frame embodiment of the presently disclosed subject matter, similar to that of FIG. 1 but showing multiple front and rear panel flap fold lines;

FIG. 34 is a representative bottom up plan view of the frame of FIG. 33;

FIG. 35 is a representative perspective view of a packaging assembly embodiment of the presently disclosed subject matter comprising a box and the frame of FIGS. 33-34 in an installed position;

FIG. 36 is a representative perspective view of the packaging assembly of FIG. 35, but having a product on the sheet beneath the front and rear central panel portions and having the left and right closure flaps of the box folded inwardly;

FIG. 37 is a representative top down plan view of a relatively large left box 314 and a relatively small right box 364, both having their closure flaps open and in a horizontal position, and a frame embodiment 310 between the left and right boxes;

FIG. 38 is a representative top down plan view of a packaging assembly 312 having the frame of FIG. 37 installed on the relatively large left box of FIG. 37;

FIG. 39 is a representative top down view of a packaging assembly 362 having the frame of FIG. 37 installed on the relatively small right box of FIG. 37;

FIG. 40 is a representative top down plan view of another frame embodiment 509 of the presently disclosed subject matter, similar to that of FIG. 33 but having a wider front panel flap fold zone with a gap region;

FIG. 41A is a perspective representative schematic view illustrating a system for installing the frames of the presently disclosed subject matter on a box;

FIG. 41B is a perspective representative schematic view of the system of FIG. 41A, illustrating the operation of the closure flap openers;

FIG. 41C is a perspective representative schematic view of the system of FIG. 41A, illustrating the operation of the adhesive applicators;

FIG. 41D is a perspective representative schematic view of the system of FIG. 41A, illustrating the application of the frame to the box;

FIG. 41E is a perspective representative schematic view of the system of FIG. 41A, illustrating the packaging of a product in the packaging assembly;

FIG. 42 is a representative top down plan view of another frame embodiment of the presently disclosed subject matter, similar to that of FIG. 34 but having windows in the fold zone and a non-linear detachment line;

FIG. 43 is a representative bottom up plan view of the frame of FIG. 42;

FIG. 44 is a representative perspective view of a packaging assembly embodiment of the presently disclosed subject matter comprising a box and the frame of FIGS. 42-43 in an installed position;

FIG. 45 is a representative perspective view of the packaging assembly of FIG. 44, but having the front and rear central panel portions lifted open and a product to be packaged placed on the sheet;

FIG. 46 is a representative perspective view of the packaging assembly of FIG. 45, but having the left and right closure flaps of the box folded inwardly on top of the central panel;

FIG. 47 is a representative perspective view of the packaging assembly of FIG. 46, but in the retained position with the box closed, having the front and rear closure flaps folded inwardly;

FIG. 48 is a representative top down plan view of another frame embodiment of the presently disclosed subject matter, similar to that of FIG. 42 but having a skewed detachment line;

FIG. 49 is a representative top down plan view of another frame embodiment of the presently disclosed subject matter, similar to that of FIG. 42 but having a non-linear detachment line with arcuate portions;

FIG. 50 is a representative top down plan view of another frame embodiment of the presently disclosed subject matter, similar to that of FIG. 42 but having a non-linear detachment line;

FIG. 51 is a representative perspective schematic view illustrating another embodiment of a system for installing the frames of the presently disclosed subject matter on a box;

FIG. 52 is a representative perspective schematic view of the system of FIG. 51, illustrating the box at the assembly staging station;

FIG. 53 is a representative perspective schematic view of the system of FIG. 51, illustrating the box at the compression station;

FIG. 54 is a representative perspective view of a ram system 700 of the presently disclosed subject matter in the retracted position 702 relative packaging assembly 12, with ram 708 having strike end 714 with arm 717;

FIG. 55 is a representative side elevation view of the ram system of FIG. 54;

FIG. 56 is a representative perspective view of the ram system 700 of FIG. 54, but in the extended position 704 relative packaging assembly 12;

FIG. 57 is a representative side elevation view of the ram system of FIG. 56;

FIG. 58 is a representative perspective view of the ram system 700 of FIG. 54, but having ram system 700 in the extended position 704 and with ram 708 having strike end 714 with roller 719; and

FIG. 59 is a representative side elevation view of the ram system of FIG. 58, but having ram system 700 in the retracted position 702.

Various aspects of the subject matter disclosed herein are described with reference to the drawings. For purposes of simplicity, like numerals may be used to refer to like, similar, or corresponding elements of the various drawings. The drawings and detailed description are not intended to limit the claimed subject matter to the particular form disclosed. Rather, the intention is to cover all modifications, equivalents, and alternatives falling within the spirit and scope of the claimed subject matter.

### DETAILED DESCRIPTION

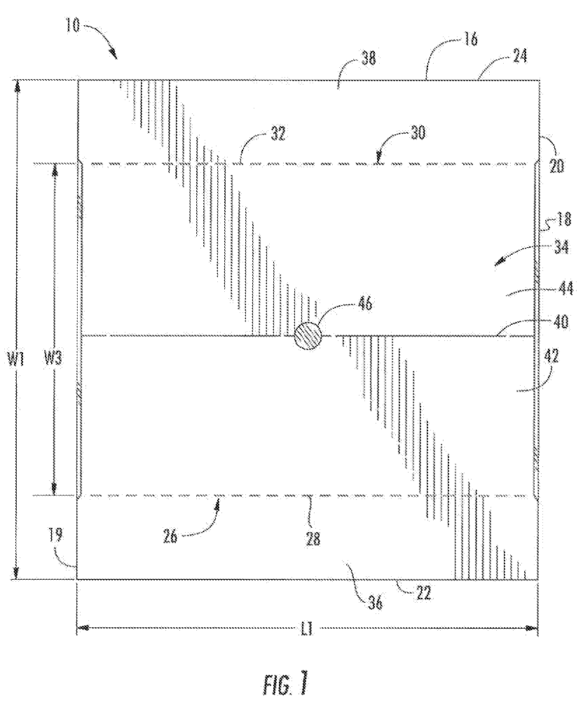

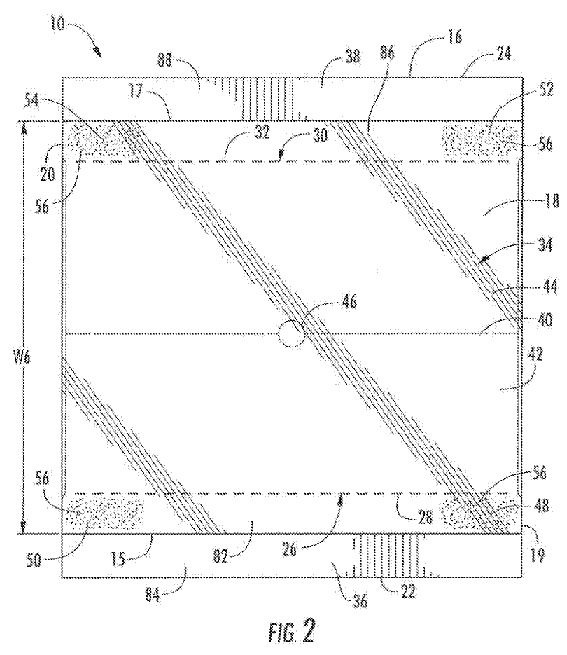

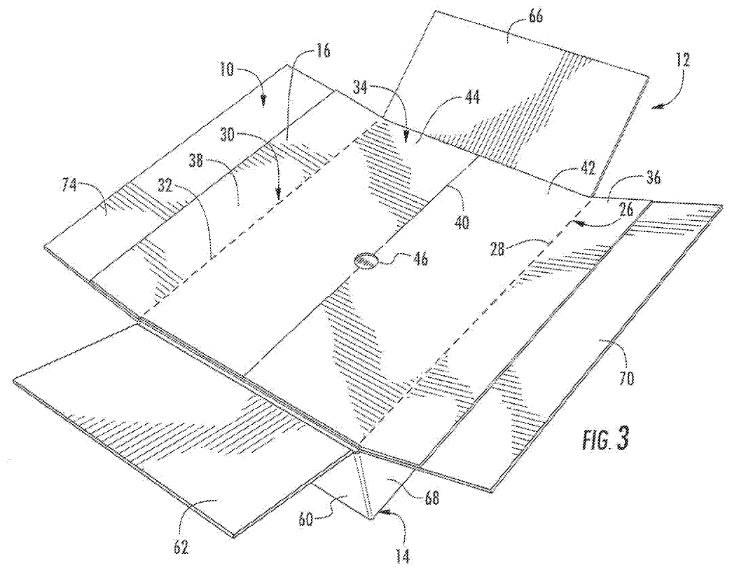

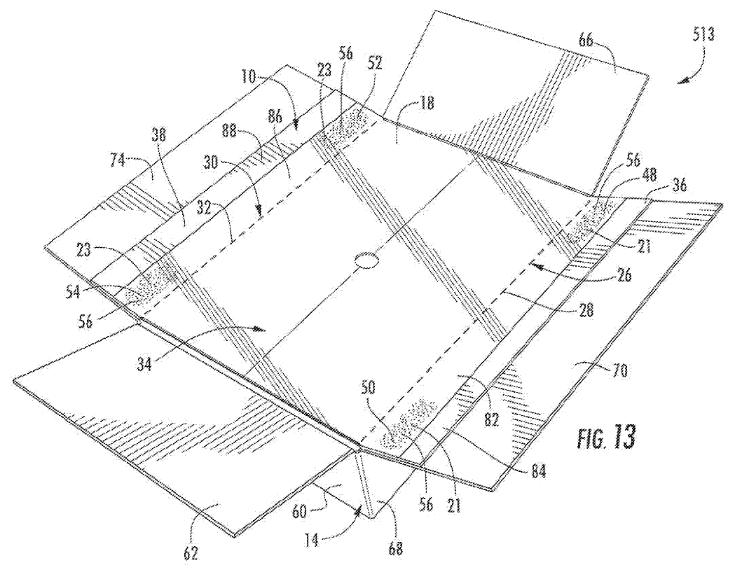

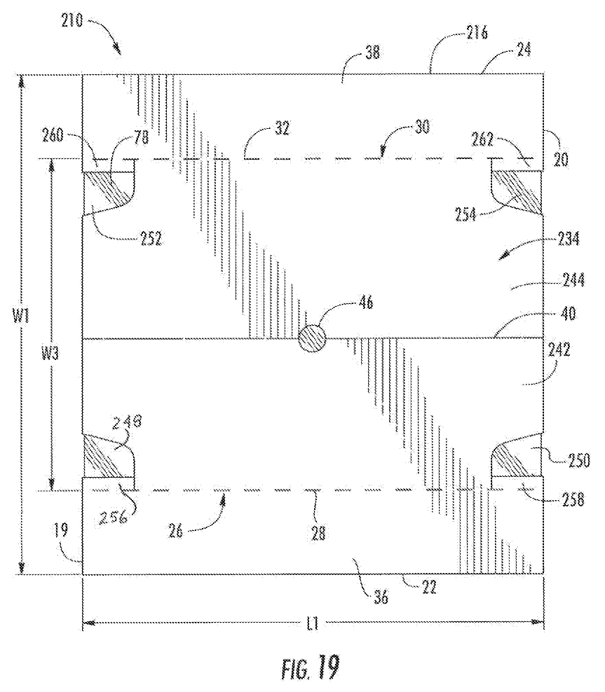

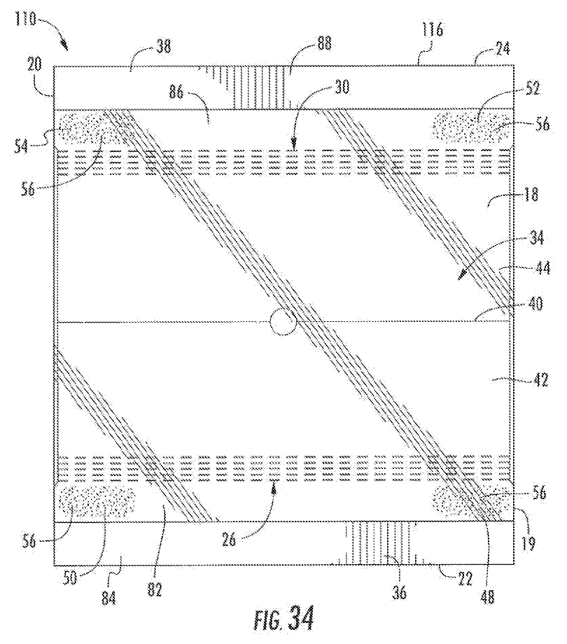

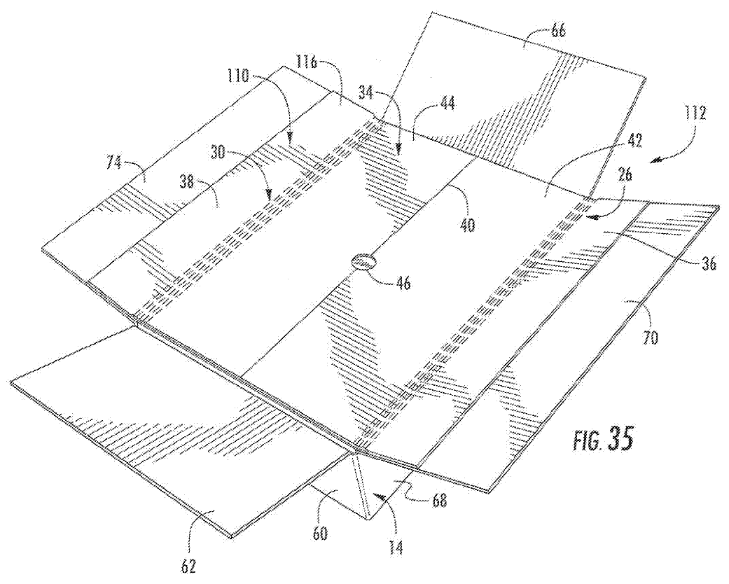

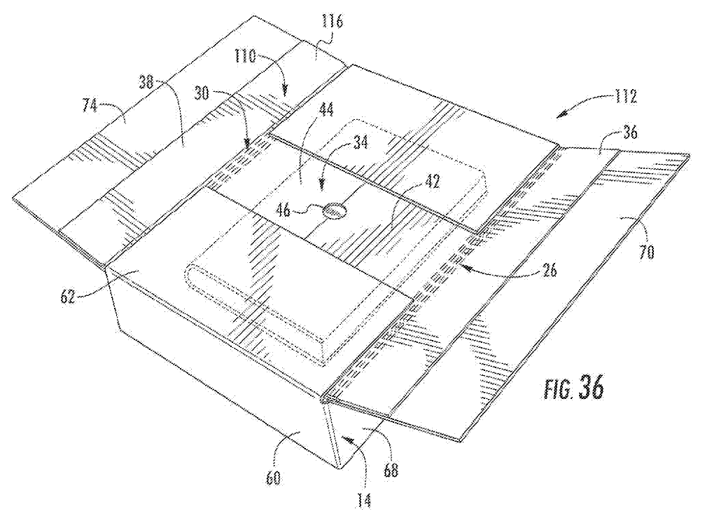

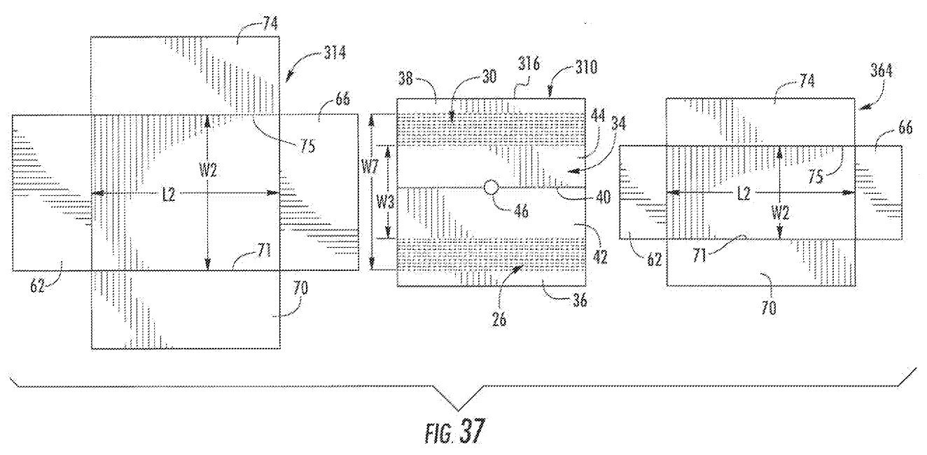

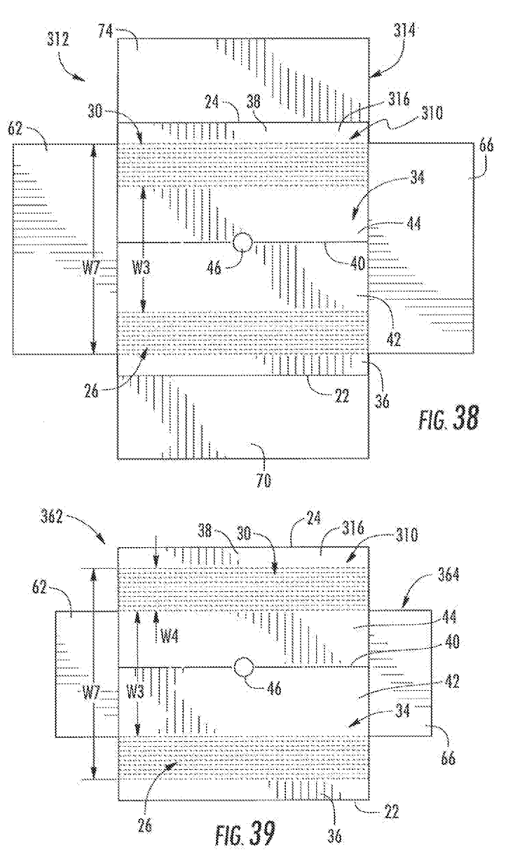

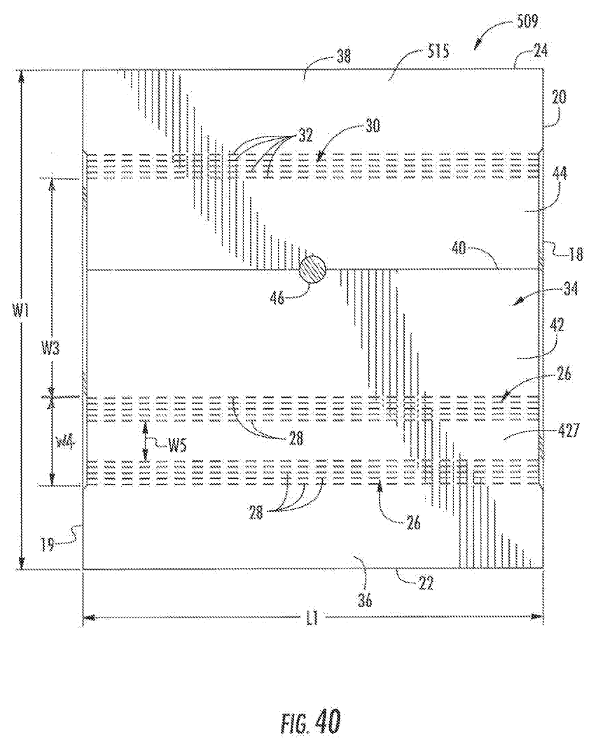

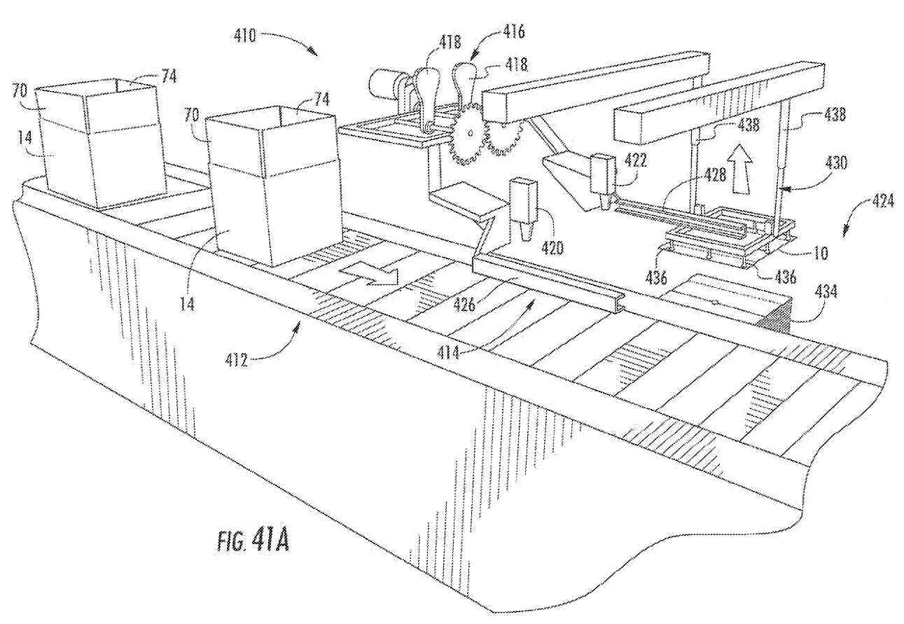

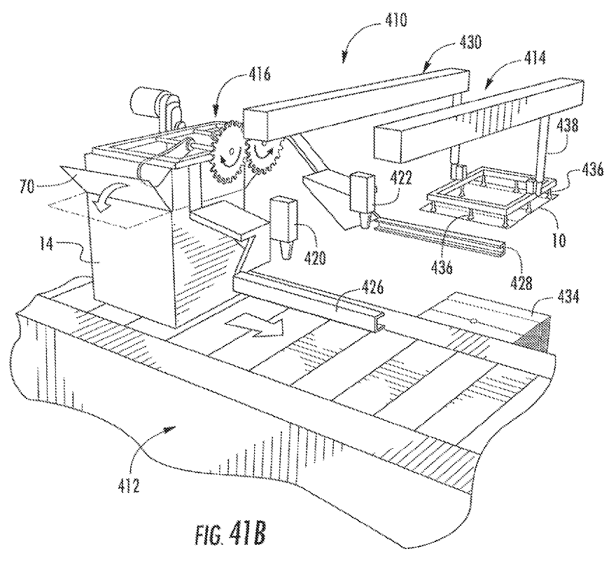

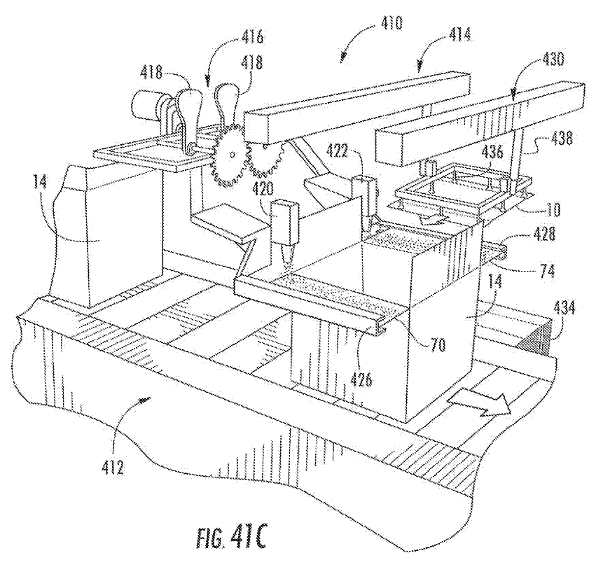

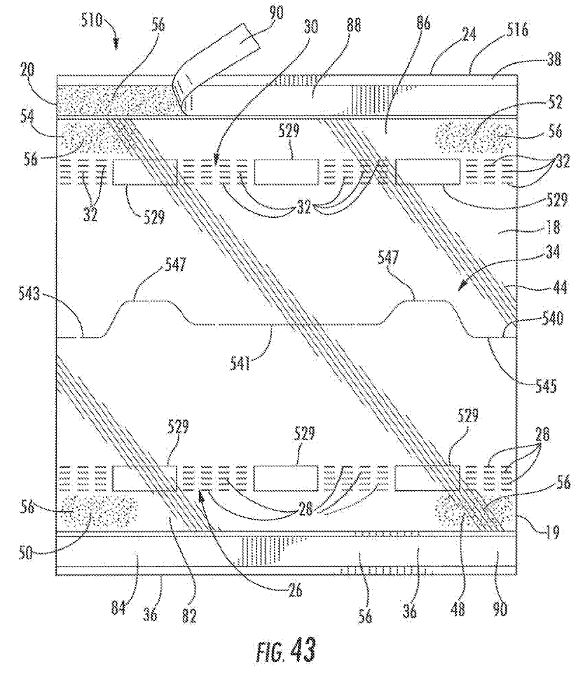

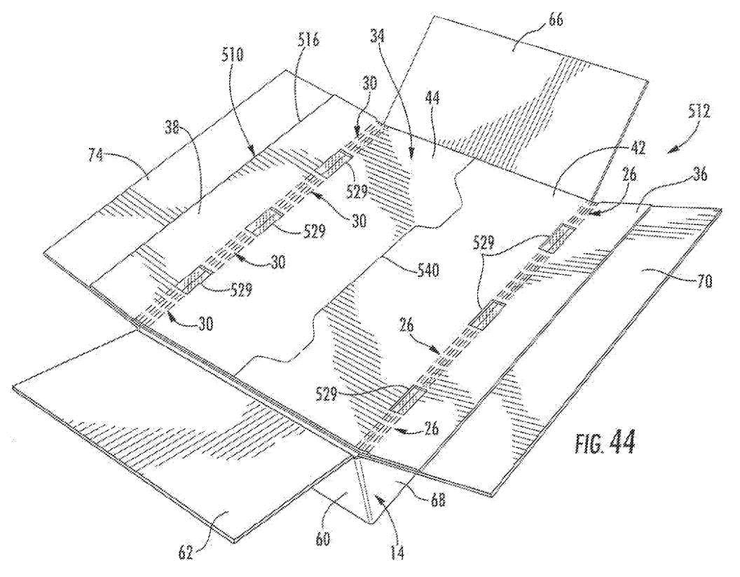

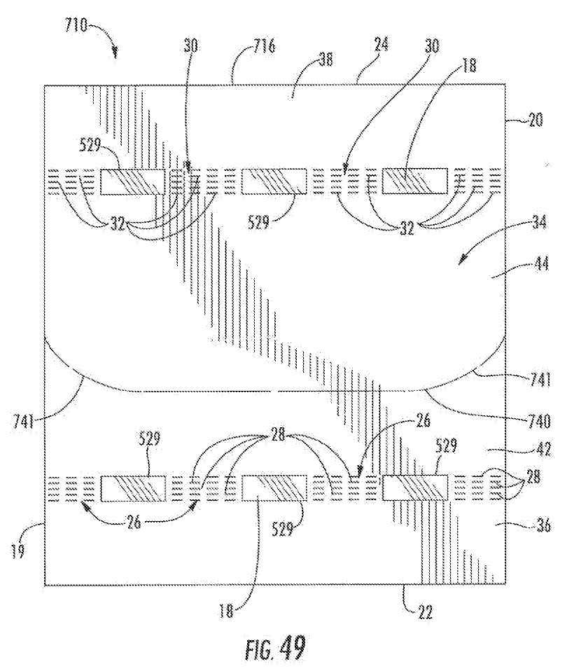

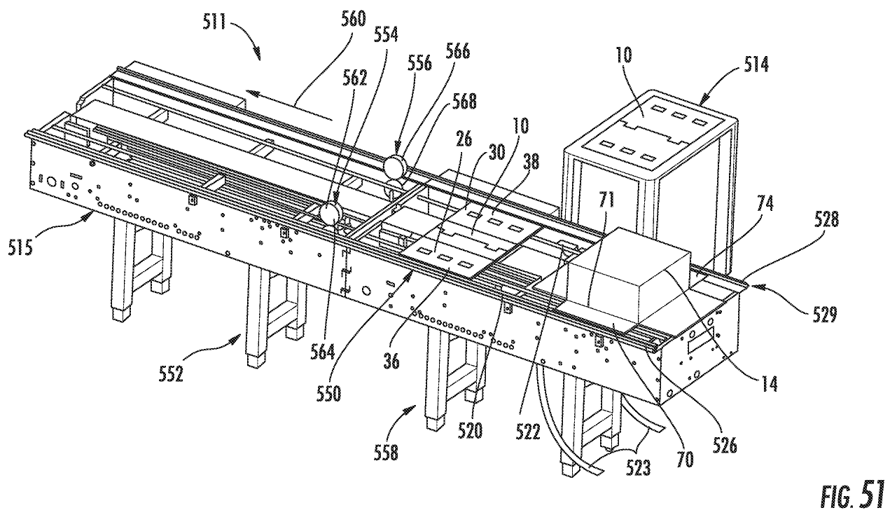

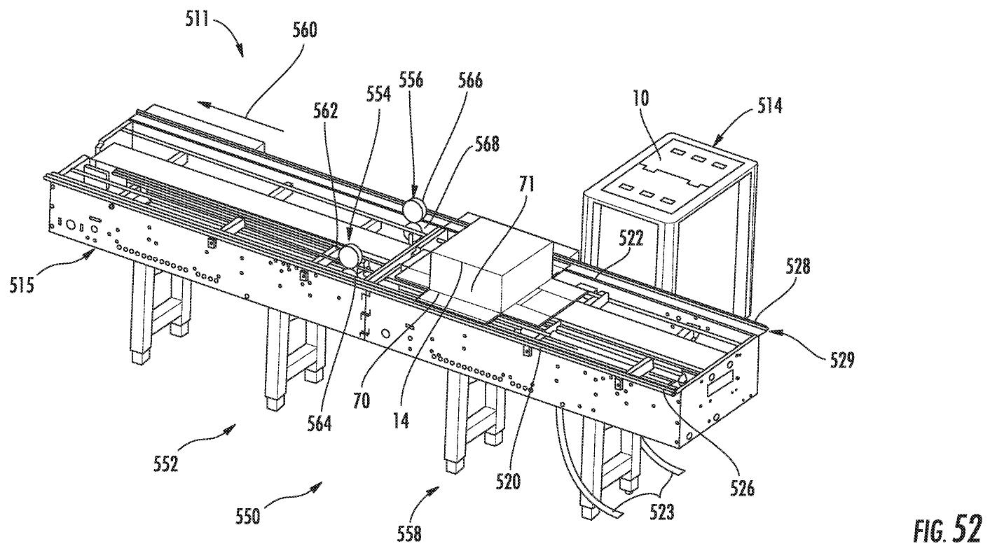

The presently disclosed subject matter includes frames, as well as packaging assemblies having a frame and a box. Exemplary frames include frame 10 (FIGS. 1 to 2), frame 110 (FIGS. 33 to 34), frame 210 (FIGS. 19 to 21), frame 310 (FIGS. 37 to 39), frame 509 (FIG. 40); frame 510 (FIGS. 42 to 43), frame 610 (FIG. 48), frame 710 (FIG. 49), and frame 810 (FIG. 50). Exemplary packaging assemblies include packaging assembly 12 (FIGS. 3 to 8), packaging assembly 112 (FIGS. 35 to 36), packaging assembly 212 (FIGS. 22 to 24), packaging assembly 312 (FIG. 38), packaging assembly 362 (FIG. 39), packaging assembly 513 (FIGS. 13-18), and packaging assembly 512 (FIGS. 44 to 46), all as described herein in more detail, and as set forth in U.S. Patent Application Ser. No. 62/166,285 and International Patent Application Serial No. PCT/US2016/028,758 (Attorney File D-45203-01), each of which is incorporated herein in its entirety by reference.

### Frames

Frames of the various disclosed embodiments (e.g., frame 10 of FIG. 1, frame 110 of FIG. 33, frame 210 of FIG. 19, frame 310 of FIG. 37, frame 509 of FIG. 40, frame 510 of FIG. 42, frame 610 of FIG. 48, frame 710 of FIG. 49, and frame 810 of FIG. 50) include a panel (e.g., panel 16 of FIG. 1, panel 116 of FIG. 33, panel 216 of FIG. 19, panel 316 of FIG. 37, panel 515 of FIG. 40, panel 516 of FIG. 42, panel 616 of FIG. 48, panel 716 of FIG. 49, and panel 816 of FIG. 50) and a sheet (e.g., sheet 18) attached to the panel.

### Panels

In embodiments of the presently disclosed subject matter, a frame (e.g., frames 10, 110, 210, 310, 509, 510, 610, 710, and 810) comprises a panel (e.g., panel 16, 116, 216, 316, 515, 516, 616, 716, and 816, respectively) having a panel width W1 measured from the outermost of front edge 22 of the panel to the corresponding outermost of rear edge 24 of the panel. (See, e.g., FIGS. 1, 19, 33, 40.) The panels have a panel length L1 measured from the outermost of left edge 19 of the panel to the corresponding outermost of right edge 20 of the panel. (See, e.g., FIGS. 1, 19, 33, 40.) The W1 and L1 measurements are made generally perpendicular to the front and rear edges, and the left and right edges, respectively. As used herein, the term “generally” when used in conjunction with terms such as “parallel” or “perpendicular” or “coplanar” or “size” is meant to indicate that the parallel or perpendicular or coplanar orientation does not require mathematical precision, but rather indicates a moderate range of deviation from absolute parallel or perpendicular or coplanar that is commonly acceptable as a level of accuracy for these terms within the container-folding field. The panel width W1 of the panel may be greater than the box width W2 (described herein) of the box for which the frame may be useful as part of a packaging assembly for retaining a product with the box.

Panels 16 and 216 have a front panel flap fold zone 26 extending generally perpendicularly from the left edge 19 to the right edge 20 of the panel and comprising one front panel flap fold line 28. (FIGS. 1, 19.) The front panel flap fold line 28 may extend generally perpendicularly from the left edge 19 to the right edge 20 of the panel. Panels 16 and 216 have a rear panel flap fold zone 30 extending generally perpendicularly from the left edge 19 to the right edge 20 of the panel and comprising one rear panel flap fold line 32. The rear panel flap fold line 32 may extend generally perpendicularly from the left edge 19 to the right edge 20 of the panel.

Panels 116, 316, 515, 516, 616, 716, and 816 have a front panel flap fold zone 26 extending generally perpendicularly from the left edge 19 to the right edge 20 of the panel and comprising a plurality of front panel flap fold lines 28. (FIGS. 33, 37, 40, 42, and 48 to 50.) For example, panel 116 has a front panel flap fold zone 26 comprising five front panel flap fold lines 28. (FIG. 33.) Each front panel flap fold line 28 may extend generally perpendicularly from the left edge 19 to the right edge 20 of the panel.

Panels 116, 316, 515, 516, 616, 716, and 816 have a rear panel flap fold zone 26 extending generally perpendicularly from the left edge 19 to the right edge 20 of the panel and comprising a plurality of rear panel flap fold lines 32. (FIGS. 33, 37, 40, 42, and 48 to 50.) For example, panel 116 has a rear panel flap fold zone 30 comprising five rear panel flap fold lines 32. Each rear panel flap fold line 32 may extend generally perpendicularly from the left edge 19 to the right edge 20 of the panel.

The front panel flap fold zone may correspond to the front closure flap fold line (described herein) of the box for which the frame may be useful as part of a packaging assembly for retaining a product with the box. The rear panel flap fold zone may correspond to the rear closure flap fold line (described herein) of the box for which the frame may be useful as part of a packaging assembly for retaining a product with the box. In this sense, the front panel flap fold zone may “correspond to” the front closure flap fold line of a box if the panel is installable on the box to align the front panel flap fold zone with the front closure flap fold line such that the pivoting or folding of the front closure flap of the box along the front closure flap fold line also pivots or folds the panel of the frame along the front panel flap fold zone. Similarly, the rear panel flap fold zone may “correspond to” the rear closure flap fold line of a box if the panel is installable on the box to align the rear panel flap fold zone with the rear closure flap fold line of the box such that the pivoting or folding of the rear closure flap of the box along the rear closure flap fold line also pivots or folds the panel of the frame along the rear panel flap fold zone. For example, the front and rear panel flap fold zones may correspond to the respective front and rear closure flap fold lines of a box if the distance from at least one of the front panel flap fold lines in the front panel flap fold zone to another of the rear panel flap fold lines in the rear panel flap fold zone is generally equal to the box width.

A “fold line” as used herein (and as depicted in the drawings as a dashed line, for example as in line 28 of FIG. 1) represents a line along which a panel, frame, or other material may be creased, crimped, embossed, perforated, scored, crushed or otherwise weakened so as to enhance the foldability of the panel, frame, or other material along the fold line. For example, front panel flap fold line 28 may include one or more through slits (not shown) extending partially along its length, leaving a sufficient portion of the fold line intact to securely join front panel flap 36 to the central panel portion 34 so that the front panel flap 36 is foldably connected to the central panel portion 34. The use of slits through a fold line may facilitate folding by reducing the amount of panel material that has to be folded.

A “fold zone” as used herein is a region of the panel comprising one fold line or one or more fold lines, for example, a plurality of fold lines. For example, front fold zone 26, as illustrated in FIG. 1, comprises only one fold line, namely, front panel flap fold line 28. Also by way of example, front fold zone 26, as illustrated in FIG. 33, comprises five fold lines, namely five front panel flap fold lines 28. Front fold zone 26, as illustrated in FIG. 40, comprises ten fold lines, namely ten front panel flap fold lines 28. A fold zone extends between the outermost fold lines of the zone. If there is only one fold line in the fold zone, then the zone is the line. A fold zone, for example, any of the front panel flap fold zone and/or the rear panel flap fold zone, may comprise at least any of 2, 4, 5, 8, and 10 panel flap fold lines; and/or at most 25, 20, 18, 15, 10, and 8 panel flap fold lines. The spacing between any two directly adjacent panel flap folds lines in a fold zone may be, for example, from 1 mm to 15 mm, from 2 mm to 4 mm, and for example, a spacing of at least any of 1 mm, 2 mm, and 4 mm; and/or at most any of 12 mm, 10 mm, 8 mm, 6 mm, and 5 mm.

Any of the front panel flap fold zone or the rear panel flap fold zone may comprise a gap region that lacks any panel flap fold lines. For example, front panel flap fold zone 26 of FIG. 40 comprises front gap region 427, which lacks any of the front panel flap fold lines 28. A panel flap fold zone has a given width W4; and a gap region of the panel flap fold zone may have a width W5 that is at least any of 25%, 30%, and 40%; and/or at most any of 50%, 40%, and 30%, of the corresponding panel flap fold zone width. (FIG. 40.)

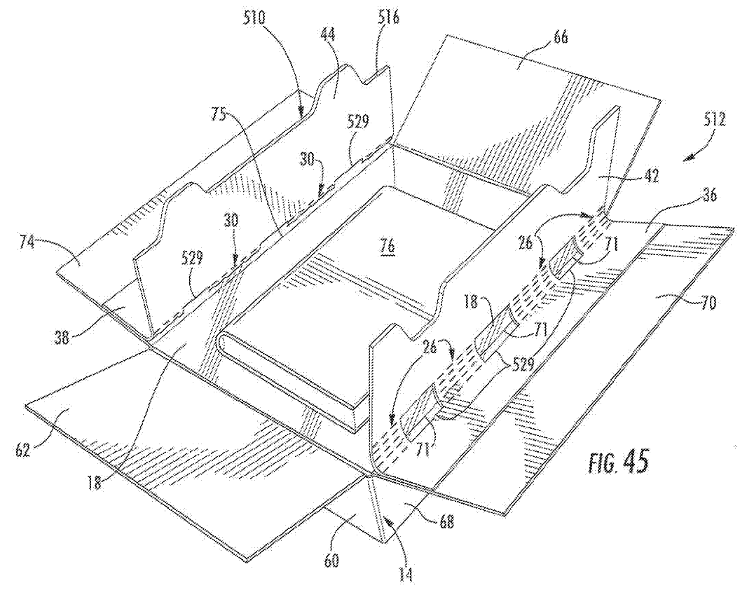

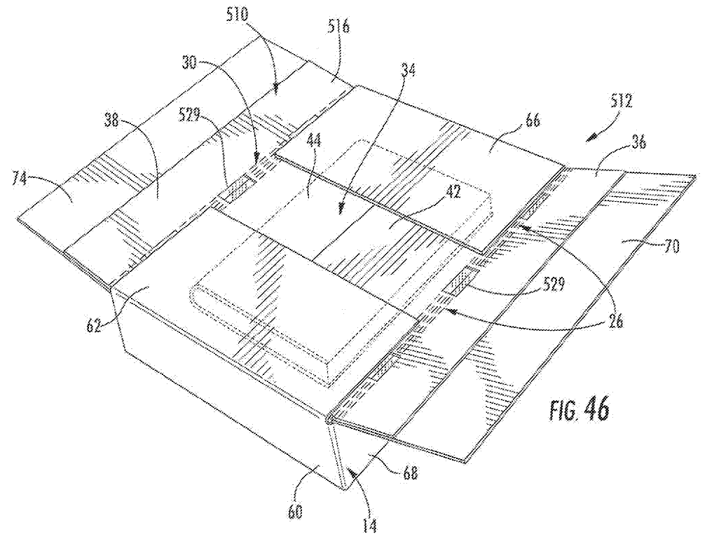

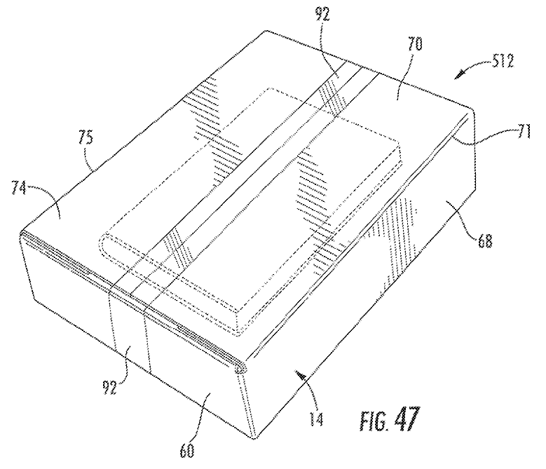

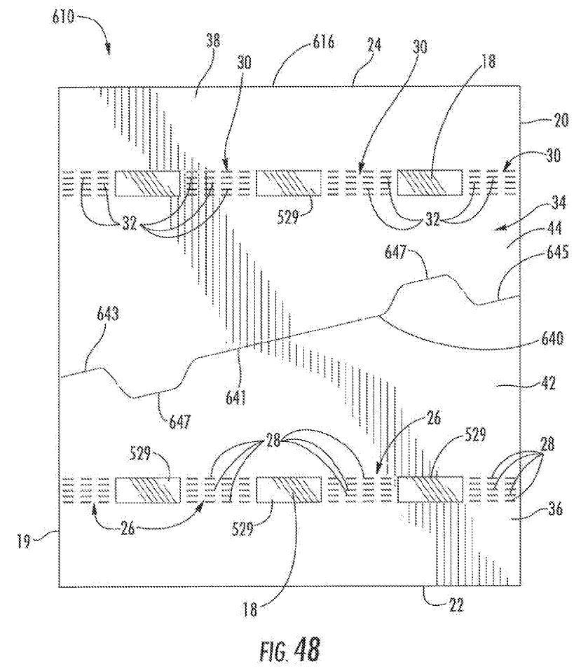

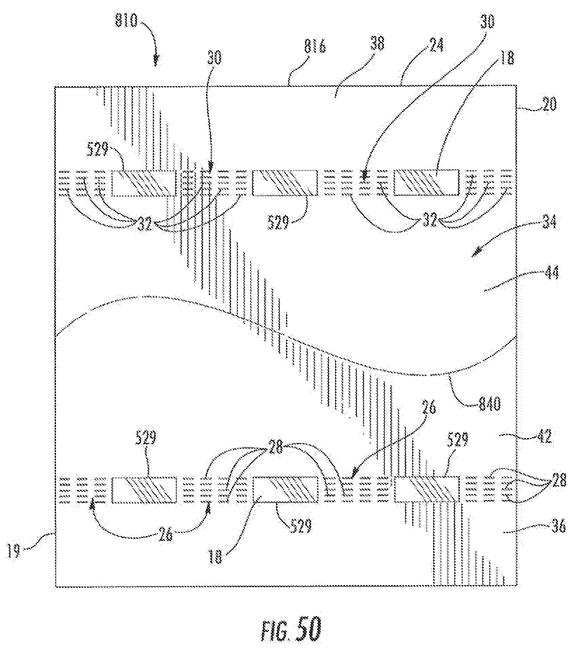

The panel may define one or more widows in the front panel flap fold zone or the rear panel flap fold zone. For example, as shown in FIGS. 42 and 48 to 50, panels 516, 616, 716, and 816, respectively, define one or more windows 529 in the front panel flap fold zone 26 and in the rear panel flap fold zone 30. The presence of windows 529 may allow easier alignment of the front panel fold zone 26 with the front closure flap fold line 71 of a box, and alignment of the rear panel flap fold zone 30 with the rear closure flap fold line 75 of a box, when positioning the frame of a packaging assembly in the installed position (discussed below), because the fold line of the box may be visible through a window in the fold zone when positioning the frame on the box. (See, e.g., FIG. 44.) Further, one or more windows in the fold zone may facilitate the folding of the front and rear central panel portions and/or or the front and rear panel flaps. (See, e.g., FIGS. 45, 47.)

Each of panels 16, 116, 216, 316, 515, 516, 616, 716, and 816 comprises a central panel portion 34 extending between the front panel flap fold zone 26 and the rear panel flap fold zone 30. Front panel flap 36 extends from the front panel flap fold zone 26 to the front edge 22 of the panel 16. Rear panel flap 38 extends from the rear panel flap fold zone 30 to the rear edge 24 of the panel 16. (FIGS. 1, 33, 38-39, 40, 42-43, and 48-50.) The panel has a central panel portion width W3 extending from the front panel flap fold zone to the rear panel flap fold zone.

In this configuration, the front panel flap 36 is foldably connected to the central panel portion 34 along the front panel flap fold zone 26, for example, foldably connected along a front panel flap fold line 28. Similarly, the rear panel flap 38 is foldably connected to the central panel portion 34 along the rear panel flap fold zone 30, for example, foldably connected along a rear panel flap fold line 32.

A detachment line extends from the left edge to the right edge of the panel in the central panel portion. The detachment line delineates a front central panel portion 42 between the detachment line and the front panel flap fold zone 26. The detachment line also delineates a rear central panel portion 44 between the detachment line and the rear panel flap fold zone 30.

For example, detachment line 40 extends from the left edge 19 to the right edge 20 of panels 16, 116, 216, 316, and 515 in the central panel portion 34. (See FIGS. 1, 19, 33, 37, and 40.) Detachment lines 540, 640, 740, and 840 extend from the left edge 19 to the right edge 20 of panels 516, 616, 716, and 816, respectively, in the central panel portion 34. (See FIGS. 42 and 48-50.)

A “detachment line” as used herein (and as depicted in the drawings as a broken line, for example as in line 40 of FIG. 1) represents a line or path along which a panel, frame, or other material has been cut or otherwise weakened or configured so as to enhance the manual detachability of one portion of the panel, frame, or other material from another portion along the detachment line. For example, a detachment line (e.g., detachment line 40) may have the majority (e.g., greater than any one of 90%, 95%, and 98%) of its length cut through its thickness to leave a minority of its length connected by spaced-apart uncut regions of its thickness to periodically join one portion of the panel, frame, or other material to another portion.

The detachment line may extend generally perpendicularly from the left edge to the right edge of the panel as illustrated in FIGS. 1, 19, 33, 37, 40, 42, 49, and 50. Alternatively, the detachment line may be “skewed” or not extend generally perpendicularly from the left edge to the right edge of the panel as illustrated in FIG. 48.

The detachment line may extend generally linearly, as illustrated in FIGS. 1, 19, 33, 37, and 40. Alternatively, the detachment line may extend generally non-linearly, as illustrated in FIGS. 42 and 48 to 50. This non-linear configuration may help to avoid detachment along the detachment line before desired. For example, the detachment line 540 comprises a central portion 541 that is offset from the end portions 543, 545 of the detachment line. Detachment line 540 also defines one or more tab portions 547. (FIGS. 42-43.) Detachment line 640 comprises a central portion 641 that is offset from the end portions 643, 645. Detachment line 640 defines one or more tab portions 647. (FIG. 48.) Detachment line 740 defines one or more arcuate portions 741. (FIG. 49.) The detachment line 840 has a curved configuration. (FIG. 50.)

The detachment line may be off-centered between the front and rear central panel portions 42, 44, in which case the front and rear central panel portions 42, 44 may be of unequal size, for example, as illustrated in FIG. 1. Alternatively, the detachment line 40 may be centered (i.e., equidistant) between the front and rear panel flaps 36, 38, in which case the front and rear central panel portions may be of generally equal size. (Not illustrated.)

The central panel portion 34 may define one or more apertures, indents, or cutaway portions as finger holds, for example, finger hold 46, which may be incorporated or aligned with detachment line 40, as illustrated in FIGS. 1 and 33.

### Embodiment of FIGS. 19 to 21

The frame 210 embodiment (FIGS. 19 to 21) comprises panel 216 having a central panel portion 234 extending between the front panel flap fold zone 26 and the rear panel flap fold zone 30. Front panel flap 236 extends from the front panel flap fold zone 26 to the front edge 22 of the panel. Rear panel flap 38 extends from the rear panel flap fold zone 30 to the rear edge 24 of the panel 216. (FIG. 19.)

In this configuration, the front panel flap 36 is foldably connected to the central panel portion 234 along the front panel flap fold zone 26, for example, foldably connected along a front panel flap fold line 28. Similarly, the rear panel flap 38 is foldably connected to the central panel portion 34 along the rear panel flap fold zone 30, for example, foldably connected along a rear panel flap fold line 32.

A detachment line 40 extends generally perpendicularly from the left edge 19 to the right edge 20 of the panel 216 in the central panel portion 234. The detachment line 40 delineates a front central panel portion 242 between the detachment line 40 and the front panel flap fold zone 26. The detachment line 40 also delineates a rear central panel portion 244 between the detachment line 40 and the rear panel flap fold zone 30. (FIG. 19.)

The front central panel portion 242 delimits a left front cutaway opening 248 at the left front extent of the front central panel portion 242 adjacent the front panel flap fold zone 26. The front central panel portion 242 also delimits a right front cutaway opening 250 at the right front extent of the front central panel portion 242 adjacent the front panel flap fold zone 26.

The rear central panel portion 244 of panel 216 delimits a left rear cutaway opening 252 at the left rear extent of the rear central panel portion 244 adjacent the rear panel flap fold zone 30. The rear central panel portion 244 also delimits a right rear cutaway opening 254 at the right rear extent of the rear central panel portion 244 adjacent the rear panel flap fold zone 30.

At least one edge of these cutaway openings 248, 250, 252, 254 may have an arcuate configuration (FIG. 19), which may be configured and sized to accommodate the closing of the left and right closure flaps of the box while the front and rear central panel portions 242, 244 are in an upward orientation during packaging operation, as discussed in more detail below.

Panel 216 has one or more of a left front tab 256, a right front tab 258, a left rear tab 260, and a right rear tab 262. Left front tab 256 is foldably connected to the front panel flap 36 along the front panel flap fold zone 26, and extends from the front panel flap fold zone 26 into the left front cutaway opening 248. Right front tab 258 is foldably connected to the front panel flap 36 along the front panel flap fold zone 26, and extends from the front panel flap fold zone 26 into the right front cutaway opening 250. Left rear tab 260 is foldably connected to the rear panel flap 38 along the rear panel flap fold zone 30, and extends from the rear panel flap fold zone 30 into the left rear cutaway opening 252. Right rear tab 262 is foldably connected to the rear panel flap 38 along the rear panel flap fold zone 30, and extends from the rear panel flap fold zone 30 into the right rear cutaway opening 254. (FIGS. 19 to 21.)

### Panel Compositions

Panel 16, and any of the panels and/or boxes of the various embodiments described herein, may comprise a substantially rigid, lightweight, foldable material, for example, the panels, or any of the portions of the panels described herein, may be formed of one or more of any of the following materials: cellulosic-based materials (e.g., cardboard, corrugated cardboard, paperboard, chipboard), plastic, and compressed foam. For example, any of the panels and boxes described herein may comprise corrugated cardboard, for example, any of single-wall B-flute, C-flute, and/or E-flute corrugated cardboard, B/C double-wall corrugated cardboard, and/or E/B double-wall corrugated cardboard; and for example having the minimum bursting strength (per Mullen Bursting Test) of any of non-test, 150, 175, 200, 250, 275, and 350 psi. The panel, and any of the panels and frames of the various embodiments described herein, may have an average thickness of, for example, at most, and/or at least, any of the following thicknesses: 0.03, 0.06, 0.12, 0.18, 0.25, 0.3, 0.4, and 0.5 inches.

### Sheets

The frame 10, 110, 210, 310, 509, 510, 610, 710, and 810 embodiments comprise sheet 18 extending across (i.e., over) the central panel portion and attached to the panel at opposing ends of the panel outside of the central panel portion. (See, e.g., FIGS. 2, 20, 34, 43.) For example, the sheet 18 may be attached to the front panel flap 36 and the rear panel flap 38 of the panel, and extend across (i.e., over) the central panel portion. (FIGS. 2, 20, 34, 43.) Further, sheet 18 may not be attached to the central panel portion that it extends across. In the drawings, sheet 18 is shown completely covering the central panel portion 34 or 234; in alternative embodiments the sheet may extend over the central panel portion and only partially cover the central panel portion (not illustrated). Also, one or more sheets, such as a total of any of one, two, three, or four may be used to extend across the central panel portion and attach to the front and rear panel flaps.

The sheet 18 has a sheet width W6 from the front edge 15 to the rear edge 17 of the sheet. (FIG. 2.) The sheet width may be greater than the box width W2 (described herein) of the box for which the frame comprising the sheet may be useful as part of a packaging assembly for retaining a product with the box.

Sheet 18 may be attached to the panel, for example to the front and rear panel flaps 36, 38 by any of the ways described herein. For example, the sheet may be continuously attached as described herein. In the embodiments of FIGS. 2, 20, 34, and 43, sheet 18 is discontinuously attached by adhesive 56 to the front panel flap 36 through the use of multiple attachment zones. For example, sheet 18 is attached to the panel by adhesive 56 in the left attachment zone 48 corresponding to the left edge of the front panel flap 36, and in the right attachment zone 50 corresponding to the right edge of the front panel flap 36. Sheet 18 is attached to the panel by adhesive 56 in the left attachment zone 52 corresponding to the left edge of the rear panel flap 38 and in the right attachment zone 54 corresponding to the right edge of the rear panel flap 38.

Sheet 18 may be continuously attached (not illustrated) to the front and rear panel flaps, for example, by an attachment zone extending continuously across the length of front panel flap 36 and rear panel flap 38.

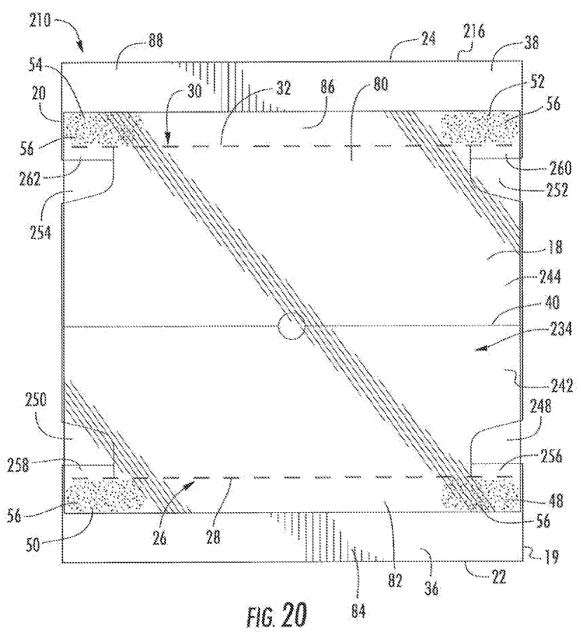

The sheet 18 may have a first side 78 attached to the front and rear panel flaps 36, 38. (FIG. 19.) The second side 80 of the sheet opposes the first side 78 of the sheet. (FIG. 20.) An adhesive may be on the second side of the sheet in the region corresponding to the front and rear panel flaps (not illustrated), which may be useful to adhere the frame to a box.

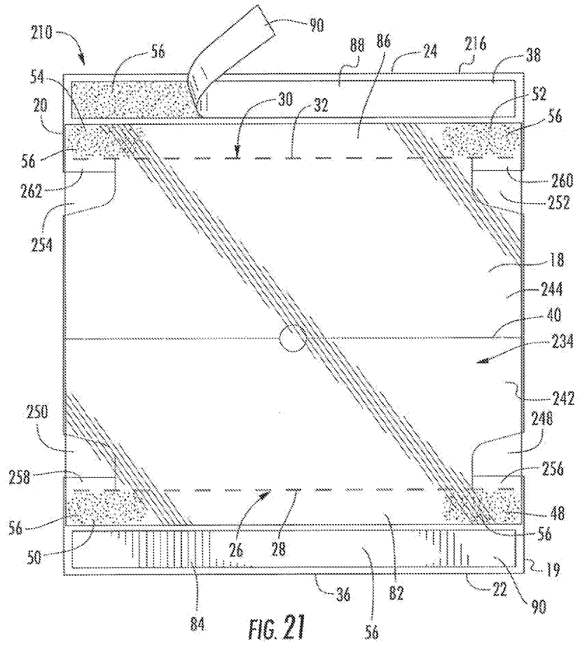

The sheet 18 may be attached to the front panel flap 36 in a sheet-covered portion 82 of the front panel flap to leave a sheet-uncovered portion 84 of the front panel flap on the same side as the sheet-covered portion 82. (FIGS. 1-2, 20-21, 33-34, 43.) The sheet 18 may be attached to the rear panel flap 38 in a sheet-covered portion 86 of the front panel flap to leave a sheet-uncovered portion 88 of the front panel flap on the same side as the sheet-covered portion 86. The frame may further have an adhesive 56 on the sheet-uncovered portion 84 of the front panel flap 36 and on the sheet-uncovered portion 88. Such adhesive may be useful to attach the frame to a box. Such adhesive may be covered by peelable cover 90, which may be removed before using the adhesive to attach the frame to a box. (FIGS. 21, 43.)

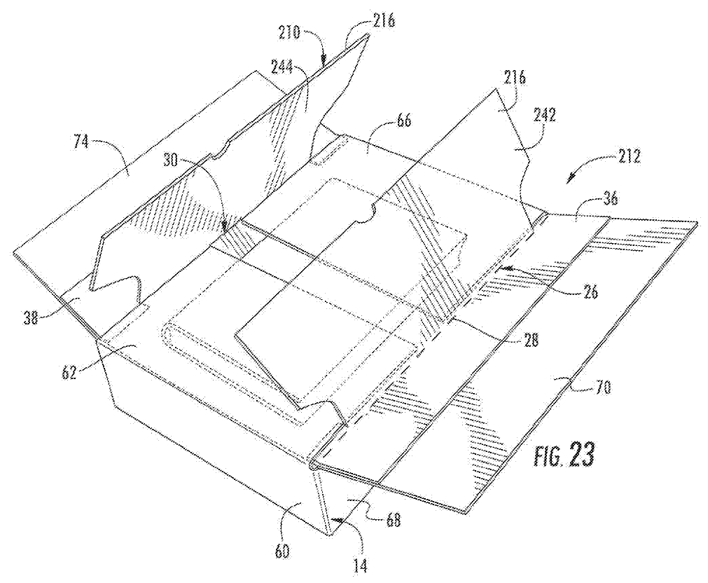

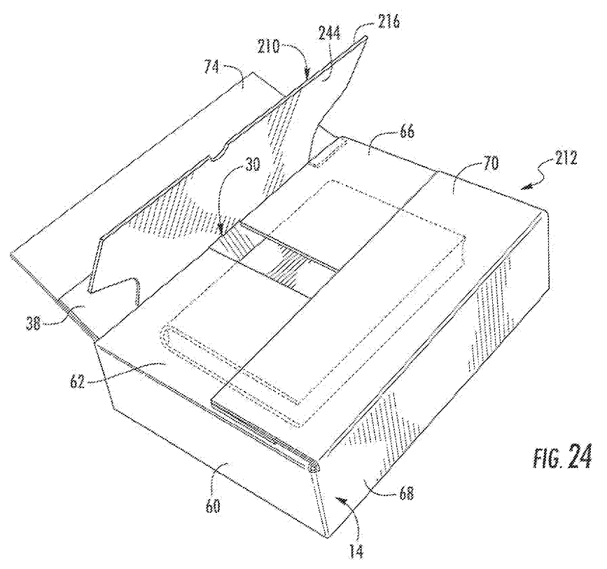

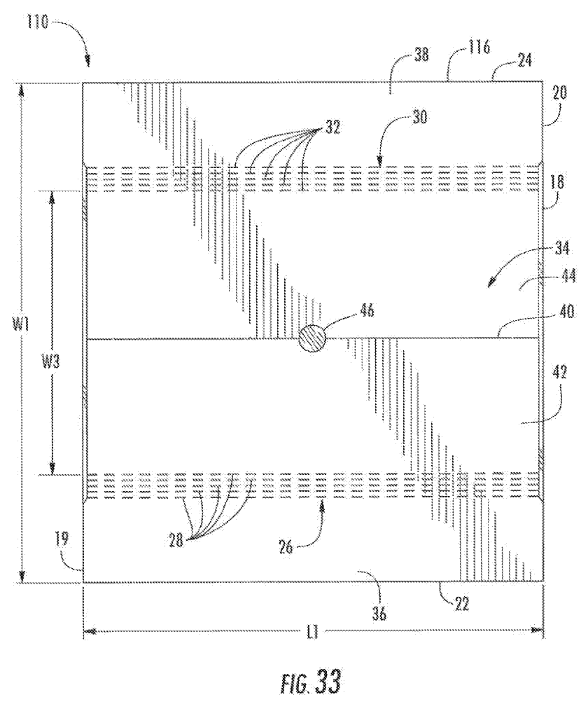

In the drawings, sheet 18 is shown attached to the panel by adhering with adhesive 56; however, the sheet may be attached to the panel, for example, by one or more of any of the following: adhering (e.g., with hot melt adhesive), gluing, heat welding, ultrasonic welding, stapling, tacking, fastening, clipping (see, e.g., U.S. Pat. No. 5,694,744 to Jones, which is incorporated herein in its entirety by reference), tab/slot engagement (see, e.g., U.S. Pat. No. 6,073,761 to Jones, which is incorporated herein in its entirety by reference), anchoring, retaining and/or securing (see, e.g., U.S. Patent Application Publication 2004/0108239 A1 to McDonald et al. published Jun. 10, 2004, which is incorporated herein in its entirety by reference, and which discloses a sleeve having pockets or pouches for receiving a flap as shown in FIGS. 24-25 and related discussion therein). The sheets of any embodiments described herein may be attached by one or more of any of the attachment ways described herein.

Useful types of adhesives for attaching sheets to panels are known to those of skill in the art, and as those of ordinary skill know depend on the composition of the materials to be adhered. For example, a polyurethane-based sheet may be adhered with a polyurethane-based adhesive, such as a water-borne aliphatic polyurethane dispersion. Also useful are adhesives of the pressure-sensitive adhesive class, in particular to attach corrugated cardboard of the frame to the box.

Sheet 18, and any of the sheets of the various embodiments described herein, may comprise any of the materials, compositions, and polymers set forth herein with respect to sheets, and may have any thickness, properties, treatments, additives, and other characteristics (e.g., flexibility, elasticity, optics, strength, elastic recovery, transparency, load tear resistance, puncture resistance) as set forth herein with respect to sheets.

Sheet 18 may have a composition and thickness providing acceptable performance properties (e.g., flexibility, elasticity, optics, strength) for the given packaging application of expected use. The sheet may have a thickness of at most any of the following: 10 mils, 6 mils, 5 mils, 4 mils, 3 mils, 2 mils, 1.5 mils, and 1 mil. (A “mil” is equal to 0.001 inch.) The sheet may also have a thickness of at least any of the following: 0.5 mils, 1 mil, 1.5 mils, 2 mils, and 3 mils.

The sheet may have an elastic recovery in either or both of the transverse and longitudinal directions of at least any of the following values: 60%, 65%, 70%, 75%, 80%, and 85%, measured according to ASTM D5459 at 100% strain, 30 seconds relaxation time, and 60 second recovery time.

The sheet may have a maximum load tear resistance in either or both of the transverse and longitudinal directions of at least any of the following values: 400, 450, 500, 550, and 600 grams force, measured according to ASTM D1004.

The sheet may have a slow puncture maximum load of at least any of the following values: 4, 4.5, 5, 5.5, 6, 6.5, and 7 pounds force, measured according to ASTM F1306 using a crosshead speed of 5 inches per minute.

The sheet may have a Young's modulus sufficient to withstand the expected handling and use conditions, yet may provide a “soft” feel that may be desirable for a packaging application. The sheet may have a Young's modulus of at least any of the following values: 2,000; 2,500; 3,000; 3,500; and 4,000 pounds/square inch. The sheet may have a Young's modulus of no more than about any of the following values: 8,000; 10,000; 15,000; 20,000; 30,000; and 40,000 pounds/square inch. The Young's modulus is measured in accordance with ASTM D882, measured at a temperature of 73□F.

The sheet may be transparent so that the packaged article (e.g., product 28) may be visible through the sheet. “Transparent” as used herein means that the material transmits incident light with negligible scattering and little absorption, enabling objects to be seen clearly through the material under typical unaided viewing conditions (i.e., the expected use conditions of the material). The transparency (i.e., clarity) of the retention sheet may be at least any of the following values: 65%, 70%, 75%, 80%, 85%, and 90%, measured in accordance with ASTM D1746.

The sheet may have a heat-shrink attribute. For example, the sheet may have any of a free shrink in at least one direction (i.e., machine or transverse directions), in each of at least two directions (i.e., machine and transverse directions), measured at any of 160□F and 180□F of at least any of the following: 7%, 10%, 15%, 20%, 25%, 30%, 40%, 50%, 55%, 60%, and 65%. Alternatively, the sheet may be non-heat shrinkable (i.e., has a total free shrink of less than 5% measured at 160□F). Unless otherwise indicated, each reference to free shrink in this application means a free shrink determined by measuring the percent dimensional change in a 10 cm×10 cm specimen when subjected to selected heat (i.e., at a certain temperature exposure) according to ASTM D 2732.

The sheet may comprise, for example, one or more fabrics, such as one or more of the following: wovens, knits, nonwovens, and openwork meshes (e.g., netting), spandex, including Lycra® brand spandex, and elastic fabrics.

The sheet may comprise one or more polymers, for example, one or more of any of the following polymers: thermoplastic polymers, polyolefins, polyethylene homopolymers (e.g., low density polyethylene), polyethylene copolymers (e.g., ethylene/alpha-olefin copolymers (“EAOs”), ethylene/unsaturated ester copolymers, and ethylene/(meth)acrylic acid), polypropylene homopolymers, polypropylene copolymers, polyvinyl chloride, various types of natural or synthetic rubber (e.g., styrene-butadiene rubber, polybutadiene, neoprene rubber, polyisoprene rubber, ethylene-propylene diene monomer (EPDM) rubber, polysiloxane, nitrile rubber, and butyl rubber), and polyurethane (i.e., any one or more of polyurethane, polyether polyurethane, polyester polyurethane, and polycarbonate polyurethane, any of which may be aliphatic and/or aromatic). The sheet may also comprise thermoplastic polyolefin elastomers (TPOs), which are two-component elastomer systems comprising an elastomer (such as EPDM) finely dispersed in a thermoplastic polyolefin (such as polypropylene or polyethylene). “Copolymer” as used in this application means a polymer derived from two or more types of monomers, and includes terpolymers, etc.

A sheet comprising polyolefin (e.g., polyethylene), polyvinyl chloride, and/or polyurethane may be useful for lightweight applications, for example, where a sheet thickness of from 2 to 4 mils may be desirable. A sheet comprising polyurethane may provide desirable elastomeric, puncture resistance, temperature resistance, and tackiness characteristics.

The sheet may comprise effective amounts of one or more of tackifiers, antiblocking agents, and slip agents—or may be essentially free of any of these components. Tackifiers, antiblocking agents, and slip agents, and their effective amounts, are known to those of ordinary skill in the art.

The sheet may be manufactured by thermoplastic film-forming processes known in the art (e.g., tubular or blown-film extrusion, coextrusion, extrusion coating, flat or cast film extrusion). A combination of these processes may also be employed.

At least one side of the sheet may be corona and/or plasma treated to change the surface energy of the sheet, for example, to increase the ability of the sheet to adhere to a panel or frame.

Films that may be useful as sheets are described in U.S. Pat. No. 6,913,147 issued Jul. 5, 2005 and entitled “Packaging Structure Having a Frame and Film,” which is incorporated herein in its entirety by reference.

### Packaging Assemblies

A packaging assembly may comprise a box and any of the various embodiments of frames of the disclosed subject matter herein.

Box 14 (as illustrated in the drawings, e.g., FIGS. 3, 22, 44) and boxes 314, 364 (FIGS. 37-39) each comprise a polyhedron-shaped storage compartment, in which the side walls, bottom, and closure flaps are polygon-shaped (e.g., rectangular). Useful box types are known to those of skill in the field, and include containers of the RSC (regular slotted container) type, AFM (all flaps meet) type, FWF (full width flaps) type, POL (partial overlap) type, and FOL (full overlap) type.

Each of boxes 14, 314, 364 comprises a left wall 60 and a left closure flap 62 foldably connected to the top of the left wall 60. Right wall 64 opposes the left wall 60. A right closure flap 66 is foldably connected to the top of the right wall 64. A front wall 68 extends from the left wall 60 to the right wall 64. Front closure flap 70 is foldably connected to the top of the front wall 68 along front closure flap fold line 71. Rear wall 72 opposes the front wall 68 and extends from the left wall 60 to the right wall 64. Rear closure flap 74 is foldably connected to the top of the rear wall 72 along rear closure flap fold line 75.

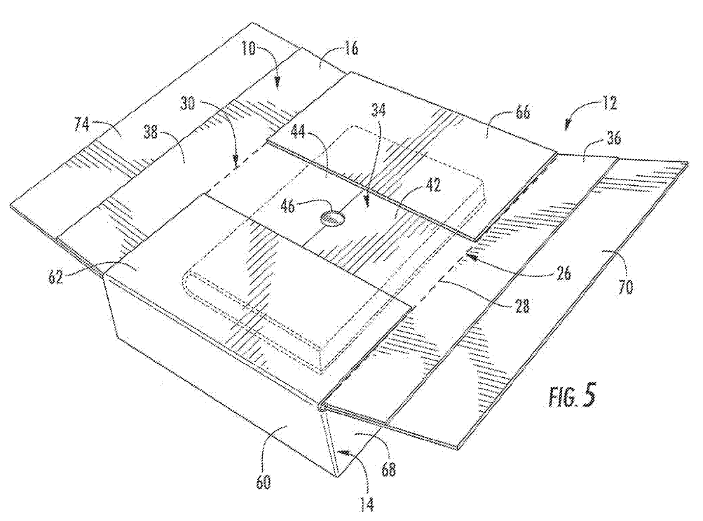

The left and right closure flaps of the box are moveable to a closed position. (See, e.g., FIGS. 5, 8-9, 12, 18, 46.) In the closed position, for example, the left and right closure flaps may cooperate to span the box opening or “meet” in the middle of the box opening. (Not illustrated.) The front and rear closure flaps of the box are moveable to a closed position. In the closed position, for example, the front and rear closure flaps may cooperate to span the box opening or “meet” in the middle. (FIGS. 6-7, 10-11, 16-17, 47.)

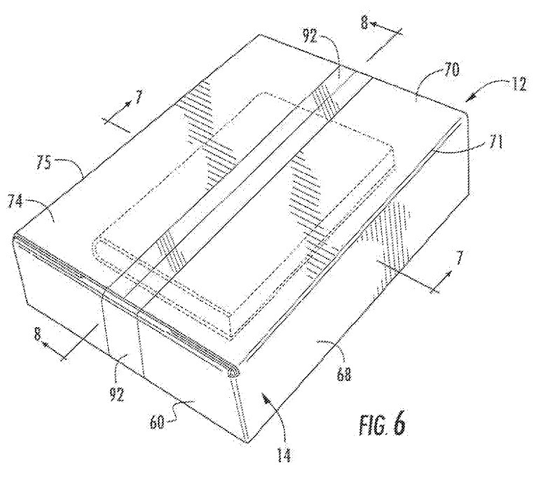

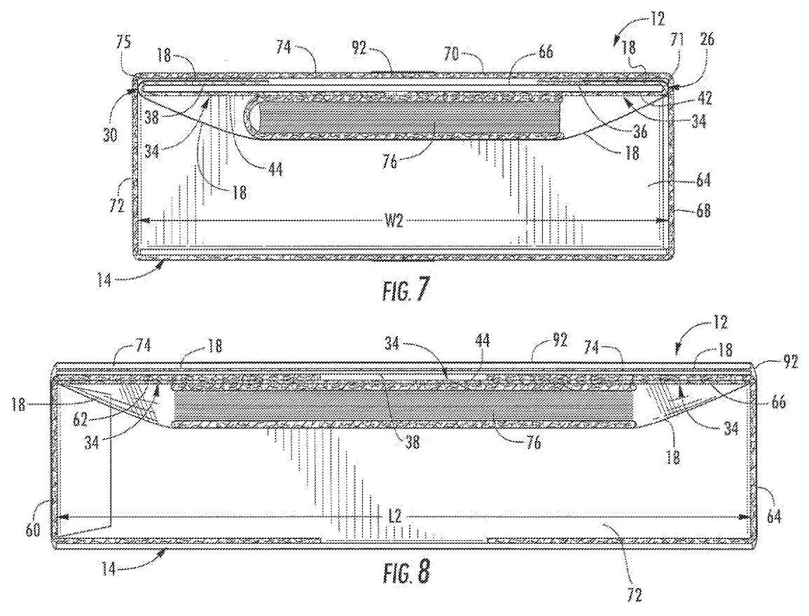

Box 14 has a given box length (i.e., internal length) L2 from the interior of the left wall 60 to the interior of the right wall 64. (See, e.g., FIGS. 8, 12, 19.) The panel length L1 (discussed above) may be less than or equal to the box length L2. Box 14 has a given box width (i.e., internal width) W2 from the interior of the front wall 68 to the interior of the rear wall 72. (FIGS. 7, 11, 17.) The central panel portion width W3 (discussed above) of the panel may be less than (FIG. 38) or equal to (FIG. 39) the box width W2.

For the packaging assemblies of the disclosed subject matter—for example, packaging assembly 12 (FIG. 3), packaging assembly 112 (FIG. 35), packaging assembly 212 (FIGS. 22-24), packaging assembly 312 (FIG. 38), packaging assembly 362 (FIG. 39), packaging assembly 513 (FIGS. 13-18), and packaging assembly 512 (FIGS. 44-47)—the frame (e.g., frames 10, 110, 210, 310, 509, 510, 610, 710, and 810) is positionable (i.e., is configured relative the box to be positioned) in an installed position (FIGS. 3-12, 13-18, 22-23, 35-36, 38-39, and 44-47) having (i) the front panel flap 36 of the frame attached to the front closure flap 70 of the box to align the front panel flap fold zone 26 with the front closure flap fold line 71 of the box, and (ii) the rear panel flap 38 of the frame attached to the rear closure flap 74 of the box to align the rear panel flap fold zone 30 with the rear closure flap fold line 75. The term “align” when used in this context herein means that the fold zone of the panel of the frame is adjacent to and corresponds with the closure flap fold line of the box, such that the folding of the closure flap along the closure flap fold line also folds the panel flap along the panel flap fold zone.

The front and rear panel flaps of the frame may be attached to the closure flaps of the box by one or more of any of the ways discussed herein for attaching the sheet to the frame. For example, an adhesive may be used to attach by adhering the frame to the box.

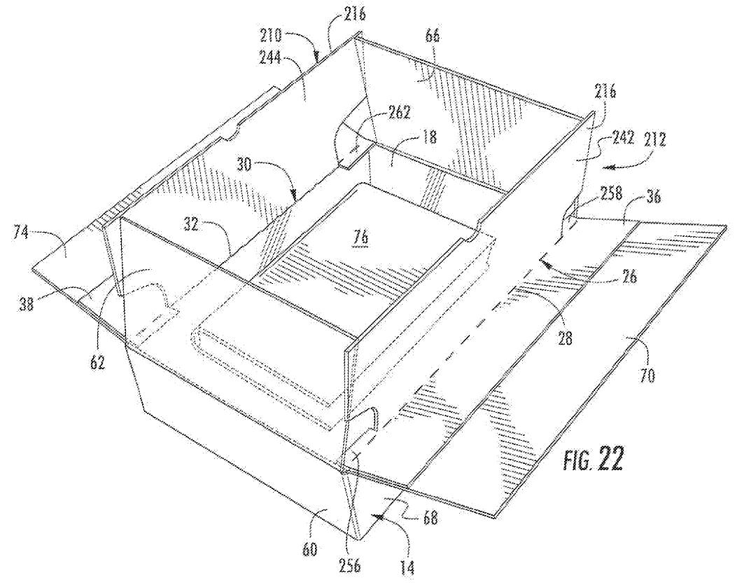

Further, in the installed position, the sheet may be between (i) the front panel flap 36 of the panel and (ii) the front closure flap 70 of the box; also, the sheet may be between (iii) the rear panel flap 38 of the panel and (iv) the rear closure flap 74 of the box. (See, e.g., packaging assembly 12 of FIGS. 3-5, 7, 9-11; packaging assembly 112 of FIGS. 35-36; packaging assembly 212 of FIGS. 22-23; packaging assembly 512 of FIGS. 44-47.)

Alternatively, in the installed position, the front panel flap 36 of the panel may be between (i) a first sheet portion 21 that is directly attached to front panel flap 36 and (ii) the front closure flap 70 of the box; also, the rear panel flap 38 of the panel may be between (iii) a second sheet portion 23 that is directly attached to rear panel flap 38 and (iv) the rear closure flap 74 of the box. (Packaging assembly 513 of FIGS. 13-18.)

The packaging assembly of the disclosed subject matter—for example, any of packaging assembly 12 (FIG. 3), packaging assembly 112 (FIG. 35), packaging assembly 212 (FIG. 22), packaging assembly 312 (FIG. 38), packaging assembly 362 (FIG. 39), packaging assembly 513 (FIG. 13), and packaging assembly 512 (FIG. 44)—is positionable (i.e., is configured so that the frame and box may be positioned) in a retained position (FIGS. 6-8, 10-12, 16-18, 47), which has (i) the frame in the installed position (described above) and (ii) the frame/box in at least the following configuration, which for clarity is further described here as a series of steps to place the packaging system in the retained position (e.g., FIGS. 6-8, 10-12, 16-18, 47):
the left closure flap 62 of the box is folded inwardly on top of the sheet;
the right closure flap 66 of the box is folded inwardly on top of the sheet;
the front closure flap 70 and front panel flap 36 are folded inwardly on top of the left and right closure flaps; and
the rear closure flap 74 and rear panel flap 38 are folded inwardly on top of the left and right closure flaps.

When a packaging assembly of any of the disclosed embodiments is in the retained position, a product 76 (for example, a book or an electronic device) that has been placed on (i.e., positioned on) the sheet 18 is retainable between the sheet 18 and one or more of the left, right, front, and rear closure flaps 62, 66, 70, 74 of the box.

Beyond this basic description above of the retained position, there are some variations and/or additional detail retained positions of the packaging assemblies of the presently disclosed subject matter, as set forth below.

For example, as illustrated in FIGS. 6-8, the packaging assembly 12 has the frame 10 in the installed position that also has (i) the sheet 18 between the front panel flap 36 of the panel and the front closure flap 70 of the box 14 and (ii) the sheet 18 between the rear panel flap 38 of the panel and the rear closure flap 74 of the box. And the packaging assembly 12 is positionable and is positioned in the retained position that also has:
the left closure flap 62 folded inwardly on top of the central panel portion 34;
the right closure flap 66 folded inwardly on top of the central panel portion 34;
the front closure flap folded 70 inwardly to place the left and right closure flaps 62, 66 between the central panel portion 34 and the front closure flap 70; and
the rear closure flap 74 folded inwardly to place the left and right closure flaps 62, 66 between the central panel portion 34 and the rear closure flap 74.

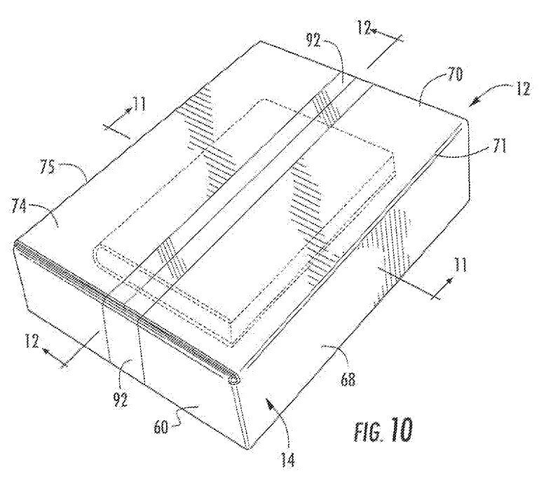

Also by way of example, as illustrated in FIGS. 10-12, the packaging assembly 12 has the frame 10 in the installed position that also has (i) the sheet 18 between the front panel flap 36 of the panel and the front closure flap 70 of the box 14 and (ii) the sheet 18 between the rear panel flap 38 of the panel and the rear closure flap 74 of the box. The packaging assembly 12 is positionable and is positioned in the retained position that also has:
the left closure flap 62 is folded inwardly beneath the central panel portion 34;
the right closure flap 66 is folded inwardly beneath the central panel portion 34;
the front closure flap 70 is folded inwardly to place the central panel portion 34 between the front closure flap 70 and the left and right closure flaps 62, 66; and
the rear closure flap 74 is folded inwardly to place the central panel portion 34 between the rear closure flap 74 and the left and right closure flaps 62, 66.

Another example, as illustrated in FIGS. 16-18, the packaging assembly 513 has the frame 10 in the installed position that also has (i) the front panel flap 36 of the panel between the first sheet portion 21 that is directly attached to front panel flap 36 and the front closure flap 70 of the box and (ii) the rear panel flap 38 of the panel is between the second sheet portion 23 that is directly attached to rear panel flap 38 sheet and the rear closure flap 74 of the box. The packaging assembly is positionable and is positioned in the retained position that also has:
the left closure flap is folded inwardly to place the sheet between the left closure flap and the central panel portion; and
the right closure flap is folded inwardly to place the sheet between the right closure flap and the central panel portion.

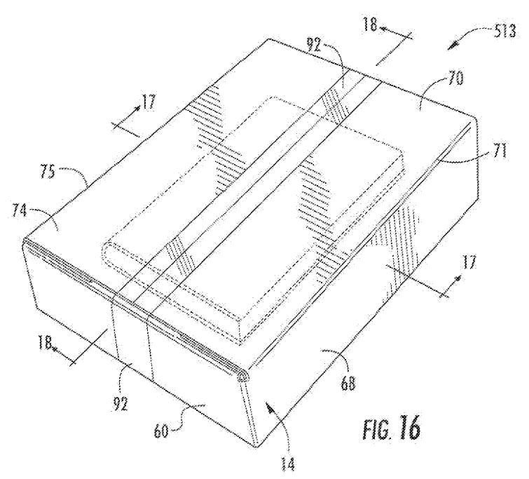

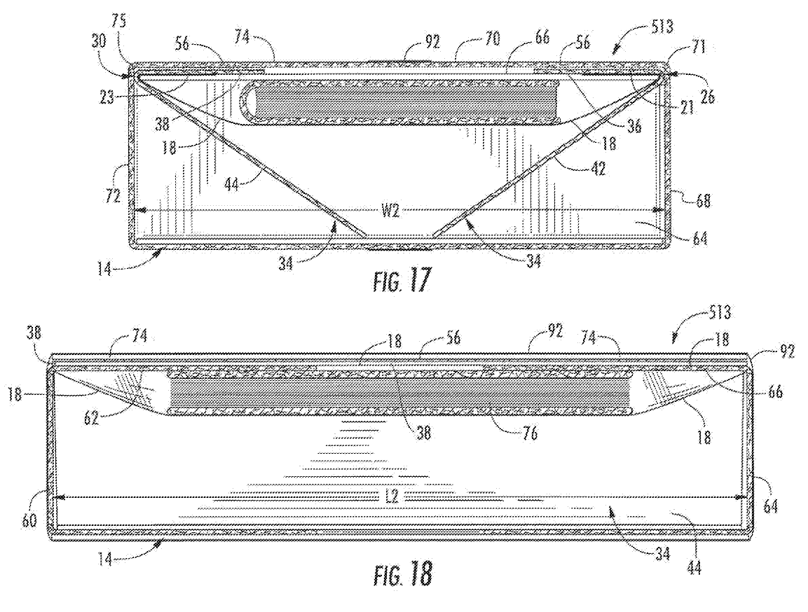

In this configuration, packaging assembly 513 in the retained position may have the frame in the installed position such that the front and rear central panel portions 42, 44 extend beneath the sheet 18. (See FIG. 17.) Alternatively, a packaging assembly in the retained position may have the front and rear central panel portions 42, 44 extending between (a) the sheet 18 and (b) the left and right closure flaps 62, 66.

After placement of any of the packaging assemblies of the presently disclosed subject matter in the retained position (e.g., such that the box has been closed), the box may be secured to maintain the packaging assembly in the retained position (and, e.g., the box in the closed configuration). For example, the box may be taped, stapled, or otherwise secured closed by methods known in the art. For example, box 14 is secured in the closed position using tape 92. (FIGS. 6, 10, 16, 47.)

### Manufacture

By using types of machinery well known to those of skill in the field, panel 16 may be cut to the desired shapes and provided with slots, openings, fold lines or detachment lines, using the known types of machinery, for example, to slit, crease, crimp, emboss, perforate, scored, cut or otherwise weaken the panel in desired regions. Adhesive 56 may be applied to the panel 16 in selected areas, for example, the attachment zones 48, 50, 52, 54. The sheet 18 may be attached to the panel 16 to make the frame by laminating or adhering the sheet with adhesive 56 to the panel. The sheet material may be provided in roll form, unrolled, and then cut to the desired length and width either before or after attachment to the panel. The packaging assembly comprising the frame and box may be provided or shipped having both configured in a lay flat arrangement. Such configurations may facilitate the provision of multiple frames in a convenient stacked or bundled arrangement (not illustrated). Box 14 may also be provided in a lay-flat configuration, and for example, finally assemble completed after shipment to the location for packaging.

### Use

A product (e.g., product 76) may be packaged using any of the packaging assemblies disclosed herein. First, the packaging assembly comprising a box and frame is provided. The frame may then be positioned in the installed position relative the box. A product 76 is placed on the sheet 18. The packaging assembly is positioned in the retained position, as described herein. As a result, the product 76 is retained between the sheet 18 and one or more of the left, right, front, and rear closure flaps.

In more detail, for example, any one of the packaging assemblies 12, 112, 212, 312, 362, 512, and 513 may be provided. The frame (e.g., frame 10, 110, 210, 310, 509, 510, 610, 710, or 810) may be positioned in the installed position relative the box. (FIGS. 3, 9, 22, 35, 41D, 44.) This aligns the front and rear panel flap fold zones with the respective front and rear closure flap fold lines of the box, so that when the closure flap is folded closed along its closure flap fold line, the panel flap of the frame is also folded along the panel flap fold zone, for example along one or more of the fold lines within the respective panel flap fold zone.

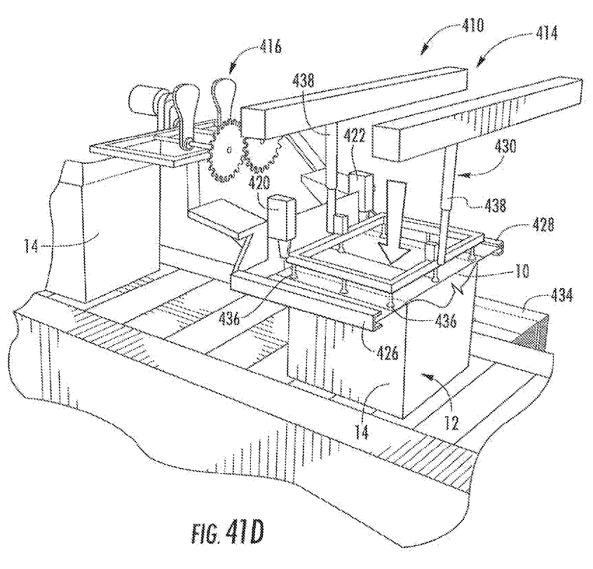

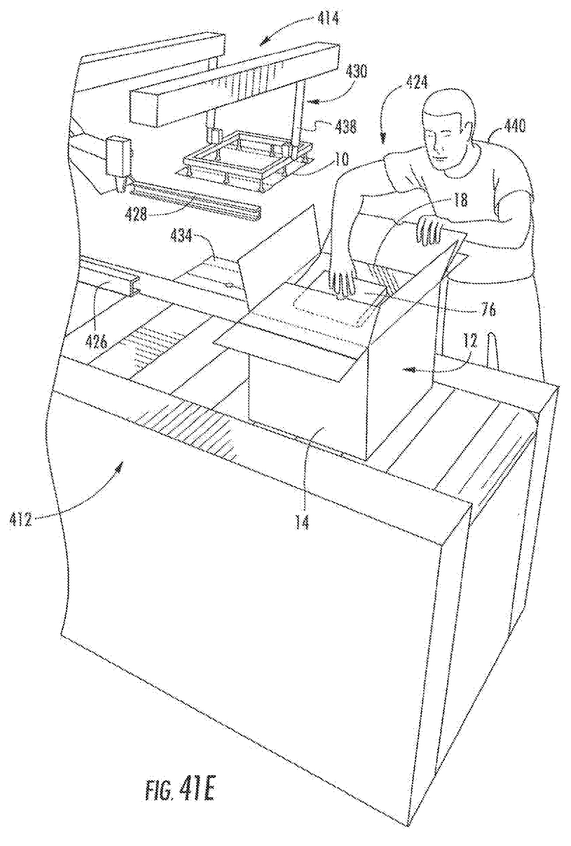

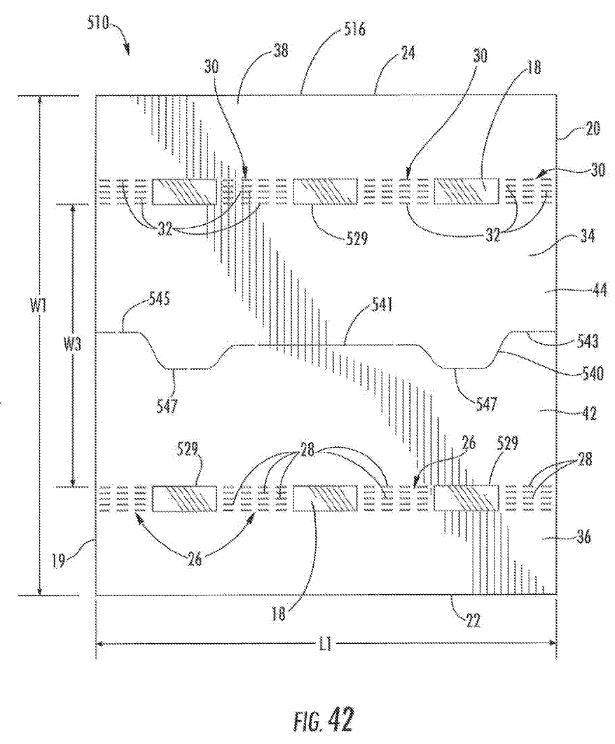

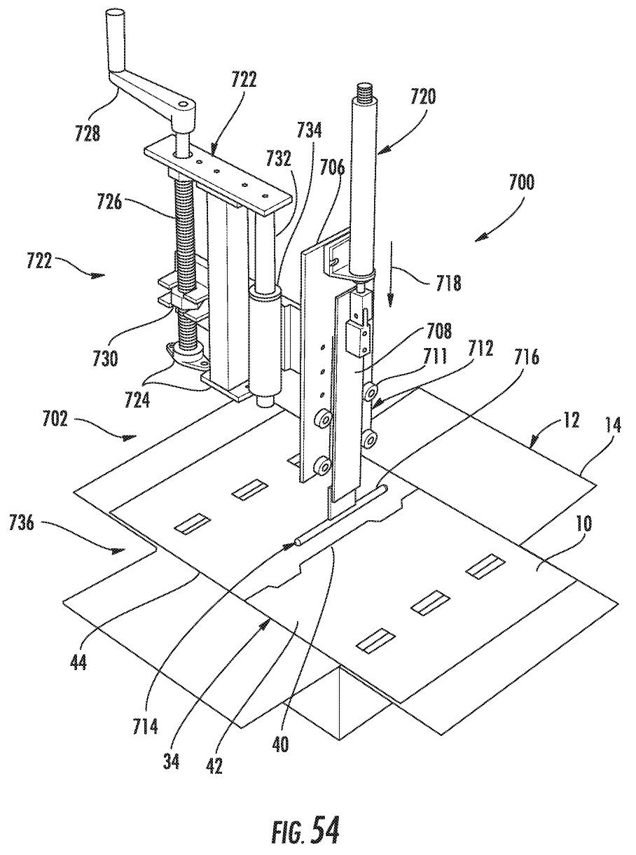

The attachment of the frame in the installed position can be accomplished by any of the attachment ways described herein. For example, an adhesive may be applied to an area of the front and rear closure flaps of the box (FIG. 41C), followed by applying the front and rear panel flaps of the frame in the same area in which the adhesive was applied to adhere the frame to the box (FIGS. 41D, 52-53). Also by way of example, an adhesive may be applied to the front and rear panel flaps 36, 38, for example, in the sheet-uncovered portions 84, 88, respectively, followed by applying the front panel flap to the front closure flap, and the rear panel flap to the rear closure flap of the box, to attach these together by adhesion. (See, e.g., FIG. 20.) Also by way of example, the adhesive 56 may be applied in the sheet-uncovered portions 84, 88 of the panel flap and covered by a peelable cover 90 (FIG. 21), which may be removed, for example manually removed, before adhesively attaching the panel flaps to the closure flaps.

In the frame installation process of applying the frame to the box, the front and rear closure flaps of the box may be maintained in a generally horizontal position (FIGS. 38, 39, 41C, 41D, 51-53) so that the frame may be installed in a generally flat configuration. The frame may be manually positioned or installed in the installed position on the box. Also, the frame may be “machine” or “automatically” positioned or installed in the installed position on the box in an automated manner, for example as illustrated in FIGS. 41A to 41E and 51-53.

The frame may be installed on the box with the sheet-side of the frame facing “down” or generally oriented toward the box opening as in FIGS. 3 and 44. Alternatively, the frame may be installed on the box with the sheet-side facing “up” or generally facing away from the box opening as in FIG. 13. In either orientation, the detachment of the panel along the frame's detachment line (e.g., detachment line 40 or 540) separates the panel. This separation may occur after the frame is in the installed position on the box, such that the unified nature of the frame during placement in the installed position facilitates its installation on the box, for example when automatically installed on a box. However, the detachment of along detachment line to separate the panel may occur before positioning the frame in an installed position on the box, in which case the frame may be positioned in the installed position on a box to provide slack or tension in the sheet by varying the distance between the detached pieces of the panel.

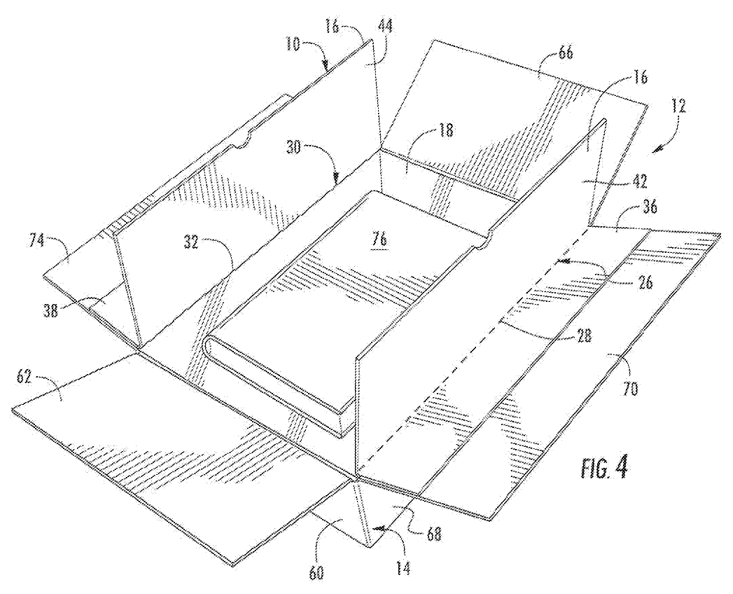

We first address the embodiments where the frame is installed in the installed position on the box with the sheet-side down. In these embodiments of a method to position the packaging assembly in a retained position retaining a product, the front and rear central panel portions of the installed frame may be lifted by pivoting them along their respective front and rear panel flap fold zones, for example by pivoting them along one or more of the panel flap fold lines in the respective fold zones. (FIGS. 4, 22, 45.) The front and rear central panel portions may be detached along the detachment line 40, 540 before or during the lifting step. The detachment and lifting may occur manually, for example, assisted by finger hold 46. The detachment of the front and rear central panel portions (42, 44 or 242, 244) reveals or exposes sheet 18. One or more products to be packaged (e.g., product 76) are placed on the revealed sheet 18. (See, e.g., FIGS. 4, 22, 45.)

In a further embodiment of the method (e.g., FIGS. 5-8, 36, 46), the front and rear central panel portions may then be folded inwardly (along front and rear fold zones 26, 30) over the product 76. The left and right closure flaps 62, 66 may be folded inwardly to place them on top of the central panel portion 34 (made up of the front and rear central panel portions 42, 44). (FIGS. 5, 36, 46.) Front and rear closure flaps 70, 74 may be folded inwardly on top of the central panel portion 34, as well as on top of the left and right closure flaps, to close the box. (FIGS. 6-8, 47.) In doing so, the front and rear closure flaps are folded inwardly along the front and rear closure flap fold lines 71, 75, which also folds the front and rear panel flaps of the frame inwardly along the front and rear panel flap fold zones that correspond to the front and rear closure flap fold lines of the box.

In folding in this manner, (i) the left and right closure flaps 62, 64 are between the central panel portion 34 and the front closure flap 70, (ii) the left and right closure flaps 62, 64 are between the central panel portion 34 and the rear closure flap 74, (iii) the front panel flap 36 is between the front closure flap 70 and the left closure flap 62, (iv) the front panel flap 36 is between the front closure flap 70 and the right closure flap 66, (v) the rear panel flap 38 is between the rear closure flap 74 and the left closure flap 62, and (vi) the rear panel flap 38 is between the rear closure flap 74 and the right closure flap 66. (See, e.g., FIGS. 6-8.)

As the front and rear closure flaps are folded to close the box and place the packaging assembly in the retained position, the sheet 18 may be tensioned to retain the one or more products 76 between the sheet and the central panel portion of the frame. (FIGS. 7-8.)

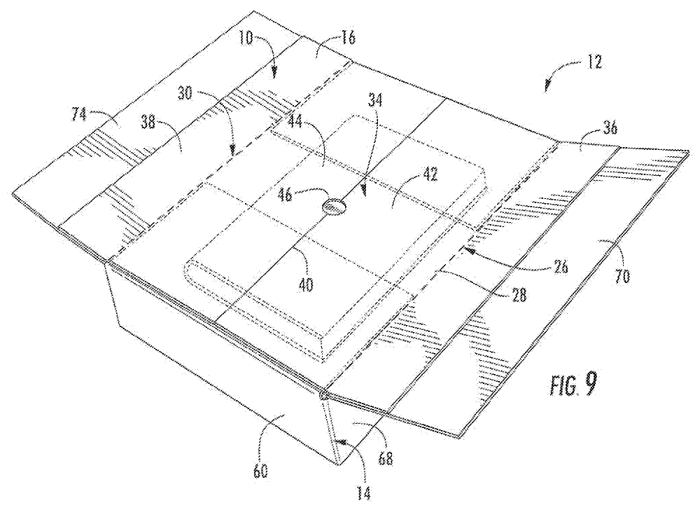

In another embodiment of the method (FIGS. 9-12, 23-24), after lifting the front and rear central panel portions and placing the one or more products to be packaged on the sheet 18 as describe above, the left and right closure flaps 62, 66 are folded inwardly to place one or more of the left and right panel flaps on top of the product. (FIG. 23.) The front and rear central panel portions (42, 44 or 242, 244) may be folded inwardly over the left and right closure flaps. (FIGS. 9, 23.) The front and rear closure flaps 70, 74 are folded inwardly on top of the central panel portion 34, 234 (made up of the front and rear central panel portions 42, 44 or 242, 244). (FIGS. 10-12, 24.) In doing so, the front and rear closure flaps are folded inwardly along the front and rear closure flap fold lines 71, 75, which also folds the front and rear panel flaps of the frame inwardly along the front and rear panel flap fold zones that correspond to the front and rear closure flap fold lines of the box.

In folding in this manner, (i) the left and right closure flaps 62, 66 are between the product and the central panel portion, (ii) the front central panel portion 42, 242 is between (a) the front closure flap 70 and (b) the left and right closure flaps 62, 66, and (iii) the rear central panel portion 44, 244 is between (a) the rear closure flap 74 and (b) the left and right closure flaps 62, 66. (See, e.g., FIGS. 10-12.)

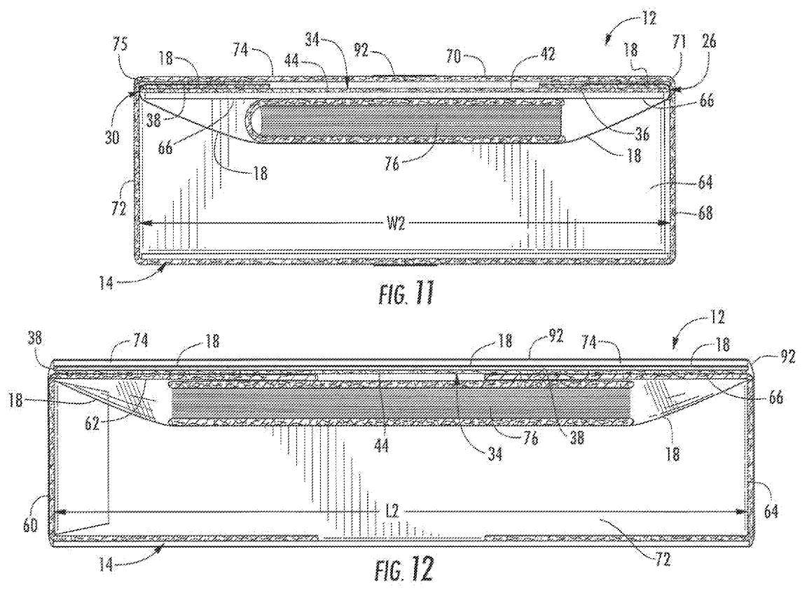

As the front and rear closure flaps are folded to close the box and place the packaging assembly in the retained position, the sheet 18 may be tensioned to retain the one or more products 76 between the sheet and the central panel portion of the frame. (FIGS. 11-12.)

If the panel has a detachment line off-centered between the front and rear central panel portions 42, 44 (e.g., FIG. 1), then the front and rear central panel portions will meet off-centered in the packaging assembly in the retained position. In this case, one of the central panel portions will be beneath the line where the front and rear closure flaps of the box meet in the middle of the box. This provides an advantage in that the central panel portion may provide additional protection to the retained product from a box cutter that may be used to open the box along the line where the front and rear closure flaps meet in the middle.

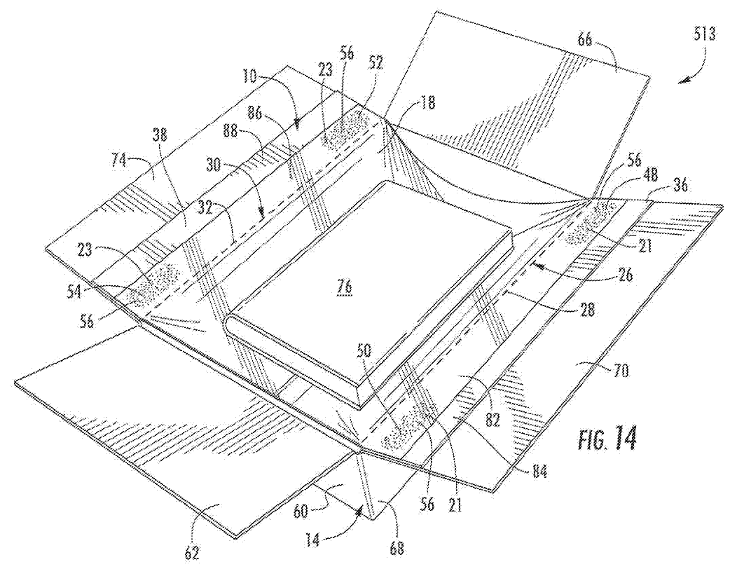

We next address the method embodiments where the frame is installed in the installed position on the box with the sheet-side up. (FIGS. 13-18.) In these embodiments of a method to position the packaging assembly in a retained position retaining a product, one or more products 76 to be packaged are placed on the upwardly facing sheet 18. In doing so, the panel 16 may detach along detachment line 40 by weight of the product, or the detachment may be effected by pressing downwardly. (FIG. 14.) The detachment of the detachment line 40 may occur later in the method, for example, when closing the closure flaps of the box. When detached along the detachment line, the front and rear central panel portions may descend into the box, where they may serve as struts (e.g., braces or other support), for example to add sidewall strength to the box, or may provide other cushioning advantage. (FIG. 17.) To facilitate the use as a strut, the front and rear central panel portions may be scored to set the desire angle of the strut relative the bottom of the box.

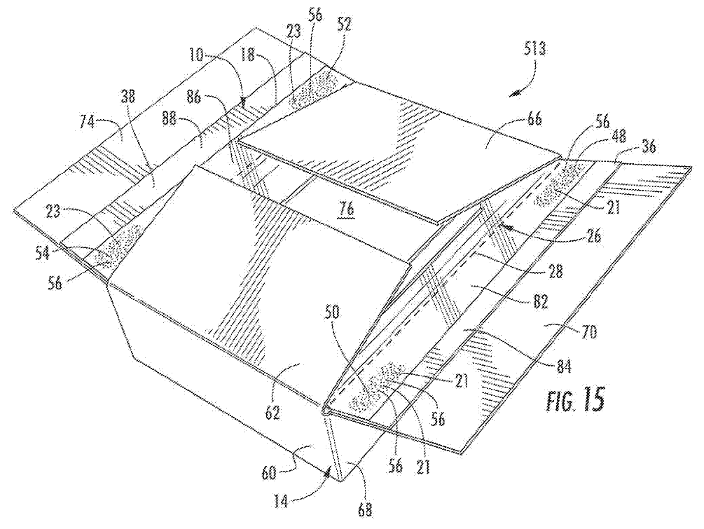

The left and right closure flaps 62, 66 are folded inwardly to place one or more of the left and right panel flaps on top of the product. (FIG. 15.) For example, the left and right closure flaps may be sized to span the box opening or meet in the middle in order to provide additional protection for the packaged products. The front and rear closure flaps 70, 74 are folded inwardly over the left and right closure flaps. In doing so, the front and rear closure flaps are folded inwardly along the front and rear closure flap fold lines 71, 75, which also folds the front and rear panel flaps of the frame inwardly along the front and rear panel flap fold zones that correspond to the front and rear closure flap fold lines of the box.

Folding in this manner places (i) the product 76 between (a) the sheet 18 and (b) the left and right closure flaps 62, 66, (ii) the right closure flap 66 between (a) the product 76 and (b) the front and rear closure flaps 70, 74, and (iii) the left closure flap 62 between (a) the product 76 and (b) the front and rear closure flaps 70, 74. (See, e.g., FIGS. 16-18.)

As the front and rear closure flaps are folded to close the box and place the packaging assembly in the retained position, the sheet 18 may be tensioned to retain the one or more products 76 between the sheet and one or more of the front, rear, left, and right closure flaps of the box. (FIGS. 17-18.)

The resulting packaging assembly of any of the methods described above may be secured in the retained position, and the box in the closed position, for example by taping the box using tape 92. (FIGS. 6, 16, 47.) Other methods of securing the box closed include applying adhesive to secure the box flaps or tying the box closed.

### Embodiments of FIGS. 37-40

As illustrated in FIGS. 37 to 39, one frame may be positionable in an installed position on more than one size of box. For example, frame 310 has front and rear panel flap fold zones 26, 30 adapted or sized to correspond to the front and rear closure flap fold lines, respectively, of more than one box. For example, frame 310 has front panel flap fold zone 26 that corresponds to both front closure flap fold line 71 of box 314 and also to front closure flap fold line 71 of box 364. Similarly, frame 310 has rear panel flap fold zone 38 that corresponds to both rear closure flap fold line 75 of box 314 and also to rear closure flap fold line 75 of box 364. Packaging assembly 312 (FIG. 38) has frame 310 in the installed position on the relatively large box 314; and packaging assembly 362 (FIG. 39) has frame 310 in the installed position on the relatively small box 364. This arrangement provides an advantage in that a frame that is useful with more than one box size may allow maintenance of a reduced inventory of frames.

In these embodiments, for example, the width W3 of the central panel portion 34 may be at most as wide as the box width W2; and for example, the width W7 between the outmost fold lines of the front and rear panel flap fold zones may be at least as wide as the box width W2.

FIG. 40 illustrates another frame that is adapted to be positionable in an installed position on more than one size of box. Frame 509 has front and rear panel flap folds zones 26, 30 of differing widths and spacing.

### Automated Assembly System

The frames of the presently disclosed subject matter may be useful in making the packaging assemblies described herein using an automated assembly system. For example, the packaging assemblies may be assembled in sequential fashion using automated assembly system 410. (FIGS. 41A to 41E.) Automated assembly system 410 includes a conveyor 412 to convey boxes 14 from a source (not shown) to a box closure flap spreader 416, then to assembly area 414, and finally to packing area 424. (FIGS. 41A to 41E.) The box flap spreader 416 includes two driven, counter-rotating bats 418 for spreading open the front and rear closure flaps 70, 74 of box 14. The assembly area includes front and rear closure flap guides 426, 428 and front and rear adhesive applicators 420, 422. The front and rear closure flap guides 426, 428 receive the front and rear closure flaps to guide and maintain the closure flaps in a desired (e.g., horizontal) position at the assembly area 414. The front and rear adhesive applicators 420, 422 apply adhesive to the front and rear closure flaps 70, 74, respectively, for example by spray application. (FIG. 41C.)

The lifter 430 obtains a frame 10 (i.e., any of the frames described herein) from the source of frames 434 (e.g., a stack of frames 10). The lifter may include suction elements 436 adapted to engage and hold frame 10 while transporting it from the frame source 432 to the assembly area 414. The suction elements may utilize vacuum functionality having on/off capability to selectively engage and disengage the frame at desired times. The lifter 430 utilizes one or more telescoping arms 438 to position the frame 10 over the front and rear closure flaps 70, 74, which are held by the front and rear closure flap guides 426, 428, respectively, and to which the adhesive applicators 420, 422 have applied adhesive. The lifter 430 applies the frame 10 to the box 14 to position the frame in the installed position relative the box (as described herein). For example, the lifter 430 may extend telescoping arms 438 to apply the frame onto the adhesive that had previously been applied on the front and rear closure flaps, thereby making packaging assembly 12. (FIG. 41D.) The suction elements 436 may disengage to release the frame 10 from the lifter 430.

Conveyor 412 conveys the packaging assembly 12 from the assembly area 414 to the packing area 424. At the packing area, a worker 440 may place a product 76 on sheet 18, and place the packaging assembly 12 in the retained position (as described herein) to retain the product between the sheet and one or more of the left, right, front, and rear closure flaps of the box.

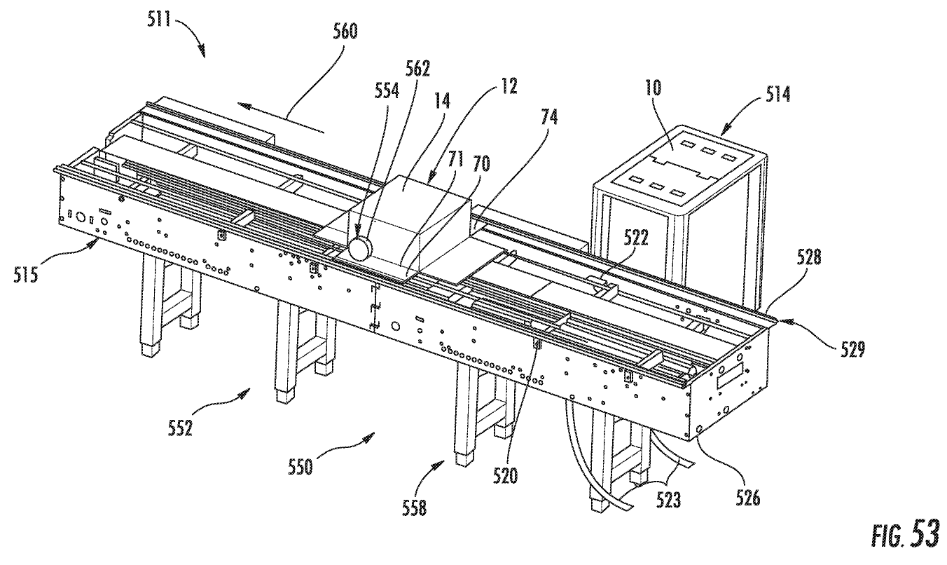

### Automated Packaging Assembly System (FIGS. 51-53)

Another embodiment is automated assembly system 511 (FIGS. 51 to 53) for sequentially assembling the packaging assemblies described herein using any of the frames described herein (i.e., to place the frame in the installed position). For simplicity in the figures, the frame is referred to as 10 and the packaging assembly as 12. Automated assembly system 511 includes a conveyor 515 to convey boxes 14 from a source (not shown) sequentially along path of travel 560 to an adhesive application station 558, an assembly staging station 550, and a compression station 552.

Box 14 is fed to conveyor 515 in an inverted (i.e., upside-down) configuration, having the front flap closure flap 70 and rear closure flap 74 of box 14 extending in an open configuration so that the opening at the “top” of the box is inverted to face downward. (FIG. 51.) The front and rear closure flaps may extend horizontally in a horizontal position relative the box. The conveyor 515 may be, for example, of the lug conveyor or push conveyor types (e.g., allowing access of objects or equipment through the belt path of travel), rather than as the representative solid belt illustrated in the figures. Such conveyors may include, for example, pins (not illustrated) for pushing the box along, as is known in the art.

Box flap guide 529 may be adjacent the conveyor to receive the front and rear closure flaps 70, 74 to orient them in the horizontal positions. Box flap guide 529 may include front closure flap guide 526 and rear closure flap guide 528. Each guide may include a track with a slot for receiving the box closure flap and maintaining its position relative side wall of the box 14 while the box is conveyed along the path of travel 560. The box flap guide 560 may extend adjacent each of one or more of the adhesive application station 558, the assembly staging station 550, and the compression station 552, for example to maintain the front and rear closure flaps 70, 74 in the horizontal position while adhesive is applied at the adhesive application station 558 and/or while the front panel flap 36 is compressed to the front closure flap 70 and the rear panel flap 38 is compressed to the rear closure flap 74 at compression station 552. The front and rear closure flap guides 526, 528 may also guide and maintain the front and rear closure flaps in the desired (e.g., horizontal) position at the assembly staging station 550.

Adhesive application station 558 is configured to apply an adhesive to selected regions of the box closure flaps. The adhesive application station 558 applies adhesive (e.g., while the box 14 is in the inverted position) to the front and rear closure flaps 70, 74 in selected regions to which the front and rear panel flaps 36, 38 of frame 10 will be adhered. Adhesive application station 558 may include front and rear applicators 520, 522 for applying an adhesive to the front and rear closure flaps 70, 74, respectively. As illustrated, the front and rear applicator 520, 522 are spray applicators are fed by adhesive supply lines 523. (FIG. 51.) The adhesive application station may apply adhesive in the form of pressure-sensitive adhesive tape, such as a double-sided adhesive tape, to the front and rear closure flaps 70, 74 in selected regions to which the front and rear panel flaps 36, 38 of frame 10 will be adhered. In such case, the front and rear applicators 520, 522 may include a tape applicator for dispensing and applying the pressure-sensitive tape.

The assembly staging station 550 receives the frame 10 from the magazine 514 configured to hold a supply of frames 10 (for example in stacked configuration) for sequential delivery to the assembly staging station. The frame 10 may be transported from the magazine 514 to the assembly staging station 550, for example, using a card feeder or a pick and place device, such as the lifter 430 as previously described in association with FIGS. 41A-D.

The assembly staging station 550 receives the frame 10 to position it along the path of travel 560 of the box and downstream from the adhesive application station where the adhesive is applied to the box front and rear closure flaps. The assembly staging station 550 positions the received frame 10 horizontally so that the front panel flap fold zone 28 is aligned with the front closure flap fold line 71 of box 14 and the rear panel flap fold zone 30 is aligned with the rear closure flap fold line 75 of the box 14 as box 14 advances along the path of travel 560. The received frame 10 is positioned beneath the box 14 along the path of travel 560. Assembly staging station 550 may include an elevator (not visible) having a platform for receiving the frame beneath the path of travel 560 of the conveyor. The conveyor moves box 14, having the applied adhesive on the closure flaps, to position it positioned over the frame 10 so that the frame is positioned for the “installed position” relative the box, having the front and rear panel flap fold zones of the frame 10 aligned with the respective front and rear closure flap fold lines 71, 75 of the box 14. To do so, the elevator beneath the conveyor path may raise the supported frame 10 to the box 14 at the assembly staging station.

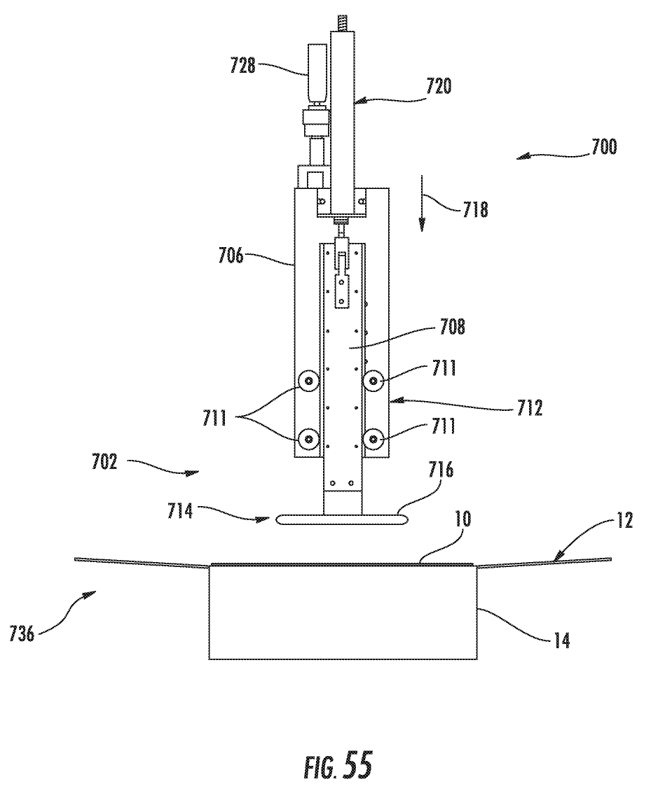

The conveyor 515 (and the elevator supporting the frame) may move the staged box and frame in concert from the assembly staging station 550 to the compression station 552 (FIG. 53). Compression station 552 includes front compressors 554, configured to apply a compressive force to complete or set the attachment of the front closure flap 70 to the front panel flap 36 of the frame 10, and rear compressors 556, configured to apply a compressive force to complete or set the attachment of the rear closure flap 74 to the rear panel flap 38 of the frame 10. In so doing, the front and rear panel flaps of the frame are adhered to the frame in the same selected regions in which the adhesive was applied to adhere the frame to the box (FIG. 53). The front compressors 554 may include a top front roller 562 and an opposing bottom front roller 564 forming a nip for receiving and compressing the front panel flap 36 to the front closure flap 70. The rear compressors 556 may include a top rear roller 566 and an opposing bottom rear roller 568 forming a nip for receiving and compressing the rear panel flap 38 to the rear closure flap 74.

The conveyor 515 may convey the resulting packaging assembly 12 (FIG. 53) from the compression station 552 to a packing area (not shown), where a worker may re-invert the box (i.e., turn the box right side up) for use in placing a product on sheet 18, and place the packaging assembly 12 in the retained position (as described herein) to retain the product between the sheet and one or more of the left, right, front, and rear closure flaps of the box.

As a result, the frame (e.g., any of frames 10, 110, 210, 310, 509, 510, 610, 710, or 810) may be positioned in the installed position relative the box (FIGS. 3, 9, 22, 35, 41D, 44, 52) to align the front and rear panel flap fold zones with the respective front and rear closure flap fold lines of the box, as described herein.

### Ram System

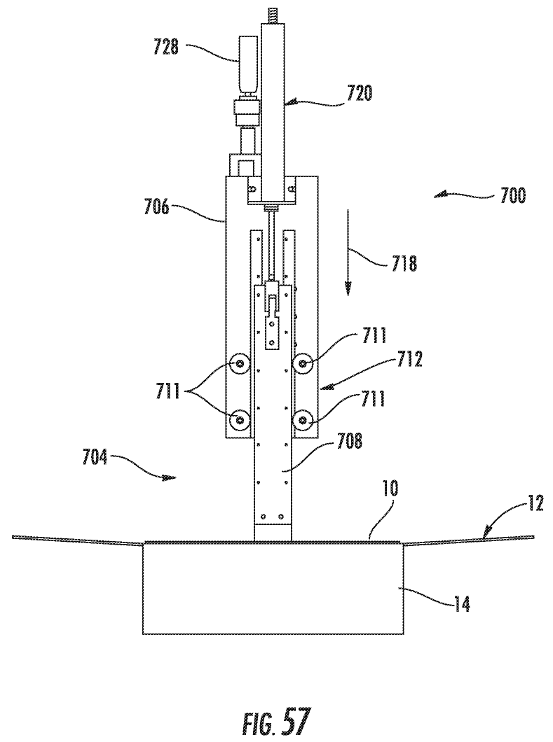

FIGS. 54 to 59 show ram system 700 that is useful for facilitating the opening of the detachment line (e.g., any of the detachment lines 40, 540, 640, 740, and 840) of any of the frames (e.g., any of frames 10, 110, 210, 310, 509, 510, 610, 710, or 810) of the packaging assemblies (e.g., any of assemblies 2, 112, 212, 312, 362, 512, and 513) disclosed herein. For simplicity in the figures, the frame is referred to as 10, the packaging assembly as 12, and the detachment line as 40.

Ram system 700 includes ram 708 movably supported by platform 706. The ram 708 may be slidably supported by linear motion bearings (i.e., bearing slides), for example, by ram guide 712 having guide rollers 711 supported by platform 706.

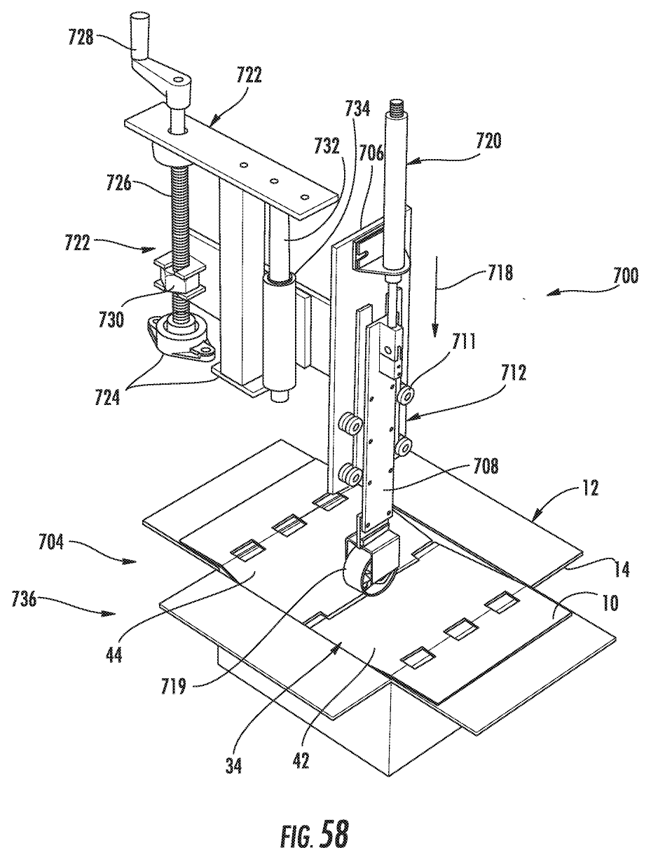

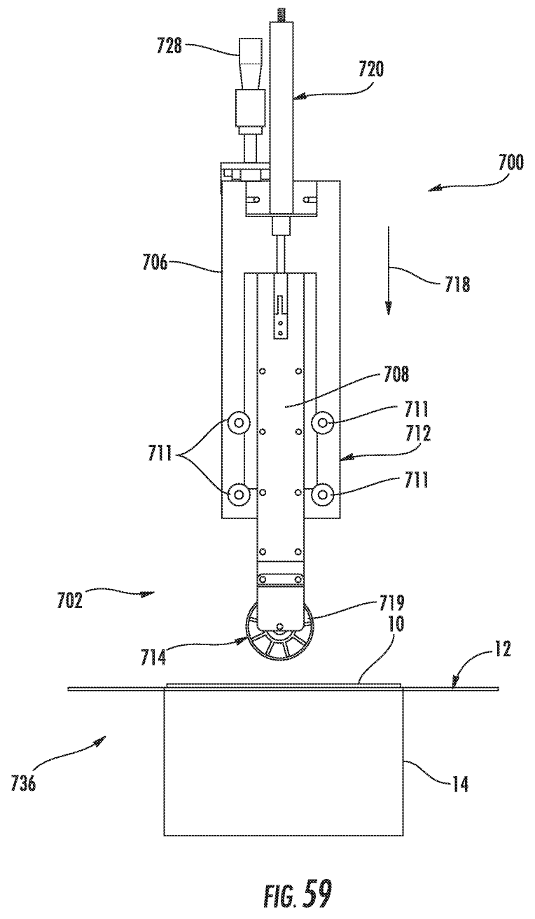

The strike end 714 of the ram 708 is configured to contact the central panel portion 34 of the frame 10 of the packaging assembly 12 when the ram is in the extended position (discussed herein) to separate the front central panel portion 42 of the frame from the rear central panel portion 44 of the frame along the detachment line 40. For example, the strike end 714 of the ram may include arm 717 positioned perpendicularly relative the path of operation 718 of the ram. (FIGS. 55 to 57.) Also by way of example, the strike end 714 of the ram may include roller 719 configured to roll along the central panel portion 34 (when the ram is in the extended position) to separate the front central panel portion 42 of the frame from the rear central panel portion 44 of the frame along the detachment line 40. (FIGS. 58 to 59.)

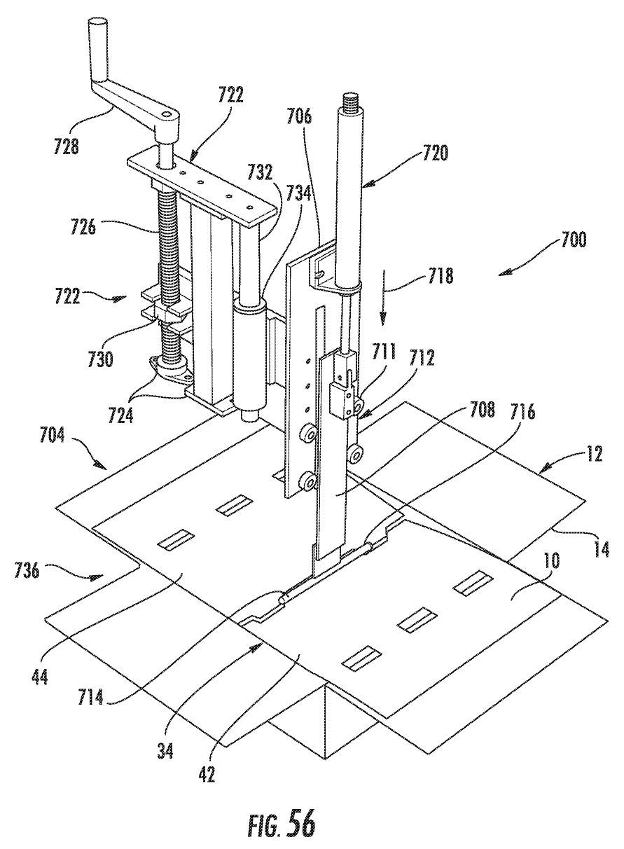

The ram 708 is movable along the path of operation 718 between a retracted position 702 (FIGS. 54-55, 59) and an extended position 704 (FIGS. 56-58). In the extended position 704, the ram 708 is extended to contact the central panel portion 34 of the frame 10 of the packaging assembly 12 to separate the front central panel portion 42 of the frame from the rear central panel portion 44 of the frame along the detachment line 40. In the retracted position 702, the ram 708 is withdrawn from the frame 10 of the packaging assembly 12.

For example, ram actuator 720 may be coupled to ram 708 so that the actuator may extend and retract to move the ram between the extended and retracted positions 704, 702. Ram actuator 720 may be supported by platform 706. The ram actuator 720 may be any type of linear actuator that provides linear motion from an energy source (not illustrated), such as electricity, pneumatic pressure, or hydraulic fluid pressure. The linear actuator may be a mechanical linear actuator that converts rotary motion (e.g., from a motor) into linear motion using, for example, such as a screw mechanism (leadscrew, screw jack, ball screw, roller screw and a rotating nut), wheel and axle mechanism (rack and pinion, chain drive, belt drive, rigid chain or belt), or cam actuator. The linear actuator may be a hydraulic actuator or a pneumatic actuator.

The ram system 700 may include a platform actuator 722 connected to platform 706 to adjust the height of the platform relative the packaging assembly. The platform actuator may include any type of actuator disclosed herein. As illustrated, the platform actuator 722 includes a rotatable threaded rod 726 that may be rotated manually by hand using handle 728. The non-rotating threaded nut 730 travels along the rod 726 as the rod rotates. The nut 730 is attached to platform 706, to raise or lower the platform (and therefore the ram 708) to a desired position relative the packaging assembly 12. The platform actuator 722 is supported by base 724. The platform 706 may also be slidably supported by column 732 by linear-motion bearing (bearing slide) 734 attached to the platform 706.

The ram system 700 may be positioned at a separation station 736 along a conveyor, for example, along conveyor 412 of FIG. 41E. The separation station 736 may be positioned along conveyor 412 between the assembly area 414 and the packing area 424 of FIG. 41E. The conveyor 412 may provide the packaging assembly 12 to the separation station 736 to position the packaging assembly under the ram system 700.

In operation, the ram system may be automatically operated (e.g., between the extended and retracted positions) when a packaging assembly 12 arrives at separation station 736, or for example, worker 440 may actuate the ram system (e.g., by foot switch), so that the ram actuator extends to move the ram 708 to the extended position to engage the central panel portion 34 of the frame of the packaging assembly and detach it along the detachment line 40. As a result, the worker can more easily access and lift the front and rear central panel portions 42, 44 to place a product 76 on sheet 18 before placing the packaging assembly 12 in the retained position (as described herein) to retain the product between the sheet and one or more of the left, right, front, and rear closure flaps of the box.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

1. A system for assembling a packaging assembly of a box and a frame: (a) the box having:
(a) a box having:
a left wall,
a right wall opposing the left wall,
a front wall extending from the left wall to the right wall,
a rear wall opposing the front wall, extending from the left wall to the right wall;
a front closure flap foldably connected to the top of the front wall along a front closure flap fold line;
a rear closure flap foldably connected to the top of the rear wall along a rear closure flap fold line;
a box length from the interior of the left wall to the interior of the right wall, and a box width from the interior of the front wall to the interior of the rear wall; and
(b) the frame having:
(i) a panel having:
a panel width from the front edge to the rear edge of the panel, wherein the panel width is greater than the box width;
a front panel flap fold zone extending generally perpendicularly from the left edge to the right edge of the panel and comprising one or more front panel flap fold lines, wherein the front panel flap fold zone corresponds to the front closure flap fold line of the box; and
a rear panel flap fold zone extending generally perpendicularly from the left edge to the right edge of the panel and comprising one or more rear panel flap fold lines, wherein the rear panel flap fold zone corresponds to the rear closure flap fold line of the box;
a central panel portion extending between the front and rear panel flap fold zones;
a front panel flap extending from the front panel flap fold zone to the front edge of the panel;
a rear panel flap extending from the rear panel flap fold zone to the rear edge of the panel; and
a detachment line extending from the left edge to the right edge of the panel in the central panel portion to delineate:
a front central panel portion between the detachment line and the front panel flap fold zone; and
a rear central panel portion between the detachment line and the rear panel flap fold zone; and
(ii) a sheet extending across the central panel portion and attached to the panel at opposing regions of the panel outside of the central panel portion;
the system comprising:
a conveyor for transporting the box along a path of travel in an inverted position with the front and rear closure flaps extending in an open configuration;
an adhesive application station for applying adhesive to the front and rear closure flaps in selected regions; and
a compression station downstream from the adhesive application station to compress (i) the front panel flap to the front closure flap and (ii) the rear panel flap to the rear closure flap in the selected regions.

2. The system of claim 1 further comprising a box flap guide adjacent the conveyor to receive the front and rear closure flaps and orient them in a horizon position.

3. The system of claim 1 wherein the box flap guide is adjacent the adhesive application station to maintain the front and rear closure flaps in a horizontal position while the adhesive is applied.

4. The system of claim 1 wherein the box flap guide is adjacent the compression station to maintain the front and rear closure flaps in a horizontal position while the front panel flap is compressed to the front closure flap and the rear panel flap is compressed to the rear closure flap.

5. The system of claim 1 further comprising an assembly staging station for receiving the frame to position the frame along the path of travel of the box downstream from the adhesive application station.

6. The system of claim 5 wherein the assembly staging station is configured to position the received frame horizontally so that the front panel flap fold zone is aligned with the front closure flap fold line of the box and the rear panel flap fold zone is aligned with the rear closure flap fold line of the box as the box advances along the path of travel.

7. The system of claim 5 wherein the assembly staging station is configured to position the received frame beneath the box along the path of travel.

8. The system of claim 5 further comprising a magazine for holding a supply of frames for delivery to the assembly staging station.

9. The system of claim 8 further comprising a lifter to engage and transport a frame from the magazine to the assembly staging station.

10. The system of claim 8 further comprising a card feeder to engage and transport a frame from the magazine to the assembly staging station.

11. The system of claim 1 wherein the adhesive application station comprises front and rear applicators for applying an adhesive to the front and rear closure flaps, respectively.

12. The system of claim 11 wherein the front and rear applicators comprise spray applicators for applying the adhesive to the front and rear closure flaps, respectively.

13. The system of claim 11 wherein the front and rear applicators comprise tape applicators for applying a pressure-sensitive tape to the front and rear closure flaps, respectively.

14. The system of claim 1 wherein the compression station comprises:
front compressors configured to compress the front panel flap to the front closure flap; and
rear compressors configured to compress the rear panel flap to the rear closure flap in the selected regions.

15. The system of claim 14 wherein:
the front compressors comprise a top front roller and an opposing bottom front roller forming a nip for receiving and compressing the front panel flap to the front closure flap; and
the rear compressors comprise a top rear roller and an opposing bottom rear roller forming a nip for receiving and compressing the rear panel flap to the rear closure flap.

16. A method of assembling a packaging assembly of a box and a frame wherein:
(a) the box has:
a left wall,
a right wall opposing the left wall,
a front wall extending from the left wall to the right wall,
a rear wall opposing the front wall, extending from the left wall to the right wall;
a front closure flap foldably connected to the top of the front wall along a front closure flap fold line;
a rear closure flap foldably connected to the top of the rear wall along a rear closure flap fold line;
a box length from the interior of the left wall to the interior of the right wall, and
a box width from the interior of the front wall to the interior of the rear wall; and
(b) the frame has:
(i) a panel having:
a panel width from the front edge to the rear edge of the panel, wherein the panel width is greater than the box width;
a front panel flap fold zone extending generally perpendicularly from the left edge to the right edge of the panel and comprising one or more front panel flap fold lines, wherein the front panel flap fold zone corresponds to the front closure flap fold line of the box; and
a rear panel flap fold zone extending generally perpendicularly from the left edge to the right edge of the panel and comprising one or more rear panel flap fold lines, wherein the rear panel flap fold zone corresponds to the rear closure flap fold line of the box;
a central panel portion extending between the front and rear panel flap fold zones;
a front panel flap extending from the front panel flap fold zone to the front edge of the panel;
a rear panel flap extending from the rear panel flap fold zone to the rear edge of the panel; and
a detachment line extending from the left edge to the right edge of the panel in the central panel portion to delineate:
a front central panel portion between the detachment line and the front panel flap fold zone; and
a rear central panel portion between the detachment line and the rear panel flap fold zone; and
(ii) a sheet extending across the central panel portion and attached to the panel at opposing regions of the panel outside of the central panel portion;
the method comprising:
conveying a box along a path of travel in an inverted position with the front and rear closure flaps extending in an open configuration;
applying adhesive to the front and rear closure flaps in selected regions while the box is along the path of travel; and
subsequently compressing (i) the front panel flap to the front closure flap and (ii) the rear panel flap to the rear closure flap in the selected regions so that the front panel flap fold zone is aligned with the front closure flap fold line of the box and the rear panel flap fold zone is aligned with the rear closure flap fold line of the box.

17. The method of claim 16 further comprising feeding the front and rear closure flaps to a box flap guide to orient the front and rear closure flaps in a horizontal position.

18. The method of claim 16 wherein the front and rear closure flaps are in the horizontal position while the adhesive is applied.

19. The method of claim 16 wherein the front and rear closure flaps are in the horizontal position while the front panel flap is compressed to the front closure flap and the rear panel flap is compressed to the rear closure flap.

20. The method of claim 16 further comprising positioning the frame horizontally and downstream from the box so that the front panel flap fold zone is aligned with the front closure flap fold line of the box and the rear panel flap fold zone is aligned with the rear closure flap fold line of the box as the box advances along the path of travel.

21. The method of claim 20 wherein the positioning step also positions the frame beneath the box along the path of travel.

22. The method of claim 16 wherein the applying step comprises spraying adhesive on the front and rear closure flaps.

23. The method of claim 16 wherein the applying step comprises applying a pressure-sensitive tape on the front and rear closure flaps.

24. The method of claim 16 wherein the compressing step comprises:
compressing the front panel flap to the front closure flap in the nip formed between a top front roller and an opposing bottom front roller; and
compressing the rear panel flap to the rear closure flap in the nip formed between a top rear roller and an opposing bottom rear roller.

25.-32. (canceled)
